(19) United States
(12) Patent Application Publication
(10) Pub. No.: US 2013/0136173 A1
(43) Pub. Date: May 30, 2013

(54) IMAGE CODING METHOD, IMAGE DECODING METHOD, IMAGE CODING APPARATUS, IMAGE DECODING APPARATUS, AND IMAGE CODING AND DECODING APPARATUS

(71) Applicant: Panasonic Corporation, Osaka (JP)

(72) Inventors: Toru MATSUNOBU, Osaka (JP); Takahiro NISHI, Nara (JP); Youji SHIBAHARA, Osaka (JP); Hisao SASAI, Osaka (JP); Kyoko TANIKAWA, Osaka (JP); Toshiyasu SUGIO, Osaka (JP); Kengo TERADA, Osaka (JP)

(73) Assignee: PANASONIC CORPORATION, Osaka (JP)

(21) Appl. No.: 13/676,220

(22) Filed: Nov. 14, 2012

Related U.S. Application Data
(60) Provisional application No. 61/559,807, filed on Nov. 15, 2011.

(51) Int. Cl. H04N 7/26

(52) U.S. Cl. CPC H04N 19/00945
USPC 375/240.08

(57) ABSTRACT

An offset unit of an image coding apparatus includes: a band setting unit which sets at least one band subject to an offset process to be variable on a per-block basis among bands obtained by dividing possible tone levels of a pixel value of a decoded image into predetermined tone level sections; a band offset pixel classification unit which classifies, as one of classes, each pixel included in a current block to be processed in the decoded image, based on whether the pixel is included in the band set by the band setting unit; a band offset value calculation unit which calculates, for each class, an offset value that is an average of differences between pixel values of an input image and pixel values of the decoded image; and a band offset processing unit which adds the offset value to the pixel value of the decoded image for each class.

### CROSS REFERENCE TO RELATED APPLICATION

The present application claims the benefit of U.S. Provisional Patent Application No. 61/559,807 filed Nov. 15, 2011. The entire disclosure of the above-identified application, including the specification, drawings and claims is incorporated herein by reference in its entirety.

### FIELD

The present disclosure relates to image coding methods, image decoding methods, image coding apparatuses, and image decoding apparatuses, and particularly to an image coding method, an image decoding method, an image coding apparatus, and an image decoding apparatus each of which involves quantization or inverse quantization using a quantization matrix.

### BACKGROUND

In recent years, there have been video-on-demand type services, for example, which include video conferences, digital video broadcasting and streaming of video content via the Internet. The number of applications for such video-on-demand type services has been increasing, and these applications depend on transmission of video data. At the time of transmission or recoding of video data, a large amount of the data is transmitted through a conventional transmission path of a limited bandwidth or is recorded onto a conventional recording medium with limited data capacity. In order to transmit video data through a conventional transmission path and to record video data onto a conventional recording medium, it is essential to compress or reduce the amount of digital data.

Thus, a plurality of video coding standards has been developed for compressing video data. Such video coding standards include, for example, the ITU-T standards denoted as H.26x, produced by the telecommunication standardization sector of the international telecommunication union, and the ISO/IEC standards denoted as MPEG-x. The most up-to-date and advanced video coding standard is currently the standard denoted as H.264/AVC or MPEG-4 AVG (see Non patent Literature 1 and Non patent Literature 2).

Furthermore, in the high efficiency video coding (HEVC) standard that is a next-generation image coding standard, various analyses have been conducted to improve the coding efficiency (see Non patent Literature 3).

### CITATION LIST

### Non Patent Literature

[Non patent Literature 1] ISO/IEC 14496-10 “MPEG-4 Part10 Advanced Video Coding”
[Non patent Literature 2] Thomas Wiegand et al, “Overview of the H.264/AVC Video Coding Standard”, IEEE TRANSACTIONS ON CIRCUITS AND SYSTEMS FOR VIDEO TECHNOLOGY, JULY 2003, PP. 1-1
[Non patent Literature 3] Joint Collaborative Team on Video Coding (JCT-VC) of ITU-T SG16 WP3 and ISO/IEC JTC1/SC29/WG11 5th Meeting: Geneva, CH, -6-23 Mar., 2011 JCTVC-E603 Title: WD3: Working Draft 3 of High-Efficiency Video Coding ver. 7 http://phenix.int-evry.fr/jct/doc_end_user/documents/5_Geneva/wg11/JCTVC-E603-v7.zip

### SUMMARY

### Technical Problem

However, in the above conventional technique, there has been a demand for improved image coding and decoding efficiency.

Thus, one non-limiting and exemplary embodiment provides an image coding method, an image decoding method, and so on which allow improvement in the coding efficiency.

### Solution to Problem

An image coding method according to an aspect of the present disclosure is an image coding method for coding an input image on a per-block basis, the method comprising: obtaining a decoded image generated by decoding a coded image resulting from coding of the input image; setting at least one band to be variable on a per-block basis among a plurality of bands obtained by dividing possible tone levels of a pixel value of the decoded image into predetermined tone level sections, the band being subject to an offset process; performing band offset pixel classification to classify, as one of classes, each pixel included in a current block to be processed in the decoded image, based on whether or not the pixel is included in the band which is set in the setting; calculating a band offset value for each of the classes, the band offset value being an offset value that is an average of differences between pixel values of the input image and pixel values of the decoded image for the pixel classified as the class; and performing a band offset process of adding the offset value to the pixel value of the decoded image for each of the classes, for the pixel classified as the class.

An image decoding method according to an aspect of the present disclosure is an image decoding method for decoding a coded stream on a per-block basis, the method comprising: obtaining a decoded image generated by decoding the coded stream, and obtaining information which is included in the coded stream and is used in an offset process; setting at least one band to be variable on a per-block basis among a plurality of bands obtained by dividing possible tone levels of a pixel value of the decoded image into predetermined tone level sections, the band being subject to the offset process; performing band offset pixel classification to classify, as one of classes, each pixel included in a current block to be processed in the decoded image, based on whether or not the pixel is included in the band which is set in the setting; performing a band offset process of adding an offset value to the pixel value of the decoded image for each of the classes, the offset value being included in the information which is obtained in the obtaining and is used in the offset process; and outputting an offset-processed image resulting from the addition of the offset value.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

According to the present disclosure, the coding efficiency can be improved.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram showing an example of a structure of an image coding apparatus.

FIG. 2 is a block diagram showing an example of a structure of an inloop filtering unit in the image coding apparatus.

FIG. 3 is a block diagram showing an example of a structure of an image decoding apparatus.

FIG. 4 is a block diagram showing an example of a structure of an inloop filtering unit in the image decoding apparatus.

FIG. 5 schematically shows an example of edge offset in the image coding apparatus.

FIG. 6 schematically shows an example of edge offset in the image coding apparatus.

FIG. 7A schematically shows an example of edge offset in the image coding apparatus.

FIG. 7B schematically shows an example of edge offset in the image coding apparatus.

FIG. 7C schematically shows an example of edge offset in the image coding apparatus.

FIG. 7D schematically shows an example of edge offset in the image coding apparatus.

FIG. 7E schematically shows an example of edge offset in the image coding apparatus.

FIG. 7F schematically shows an example of edge offset in the image coding apparatus.

FIG. 8 schematically shows an example of band offset in the image coding apparatus.

FIG. 9 schematically shows an example of band offset in the image coding apparatus.

FIG. 10 schematically shows an example of band offset in the image coding apparatus.

FIG. 11 is a block diagram showing an example of a structure of an offset unit in the image coding apparatus.

FIG. 12 is a block diagram showing an example of a structure of an offset unit in the image decoding apparatus.

FIG. 13 is a flowchart showing an example of an operation of the offset unit in the image coding apparatus.

FIG. 14 is a flowchart showing an example of an operation of the offset unit in the image decoding apparatus.

FIG. 15 is a block diagram showing an example of a structure of an offset unit in an image coding apparatus according to Embodiment 1.

FIG. 16 is a block diagram showing an example of a structure of an offset unit in an image decoding apparatus according to Embodiment 1.

FIG. 17 is a flowchart showing an example of an operation of the offset unit in the image coding apparatus according to Embodiment 1.

FIG. 18 is a flowchart showing an example of an operation of the offset unit in the image decoding apparatus according to Embodiment 1.

FIG. 19A schematically shows an example of band setting for fixed bands.

FIG. 19B schematically shows an example of band setting in an SAO band offset classification method according to Embodiment 1.

FIG. 19C schematically shows an example of band setting in the SAO band offset classification method according to Embodiment 1.

FIG. 19D schematically shows an example of band setting in the SAO band offset classification method according to Embodiment 1.

FIG. 19E schematically shows an example of band setting in the SAO band offset classification method according to Embodiment 1.

FIG. 20A schematically shows an example of band setting for fixed bands.

FIG. 20B schematically shows an example of band setting in the SAO band offset classification method according to Embodiment 1.

FIG. 20C schematically shows an example of band setting in the SAO band offset classification method according to Embodiment 1.

FIG. 20D schematically shows an example of band setting in the SAO band offset classification method according to Embodiment 1.

FIG. 20E schematically shows an example of band setting in the SAO band offset classification method according to Embodiment 1.

FIG. 21A schematically shows an example of band setting for fixed bands.

FIG. 21B schematically shows an example of band setting in the SAO band offset classification method according to Embodiment 1.

FIG. 22 schematically shows an example of band setting in the SAO band offset classification method according to Embodiment 1.

FIG. 23 shows overall configuration of a content providing system for implementing content distribution services.

FIG. 24 shows an overall configuration of a digital broadcasting system.

FIG. 25 is a block diagram showing an example of a configuration of a television.

FIG. 26 is a block diagram showing an example of a configuration of an information reproducing/recording unit that reads and writes information from and on a recording medium that is an optical disk.

FIG. 27 shows an example of a configuration of a recording medium that is an optical disk.

FIG. 28A shows an example of a cellular phone.

FIG. 28B is a block diagram showing an example of a configuration of a cellular phone.

FIG. 29 shows a structure of multiplexed data.

FIG. 30 schematically shows how each stream is multiplexed in multiplexed data.

FIG. 31 shows how a video stream is stored in a stream of PES packets in more detail.

FIG. 32 shows a structure of TS packets and source packets in the multiplexed data.

FIG. 33 shows a data structure of a PMT.

FIG. 34 shows an internal structure of multiplexed data information.

FIG. 35 shows an internal structure of stream attribute information.

FIG. 36 shows steps for identifying video data.

FIG. 37 is a block diagram showing an example of a configuration of an integrated circuit for implementing the moving picture coding method and the moving picture decoding method according to each of embodiments.

FIG. 38 shows a configuration for switching between driving frequencies.

FIG. 39 shows steps for identifying video data and switching between driving frequencies.

FIG. 40 shows an example of a look-up table in which video data standards are associated with driving frequencies.

FIG. 41A shows an example of a configuration for sharing a module of a signal processing unit.

FIG. 41B shows another example of a configuration for sharing a module of the signal processing unit.

### DESCRIPTION OF EMBODIMENTS

### Underlying Knowledge Forming Basis of the Present Disclosure

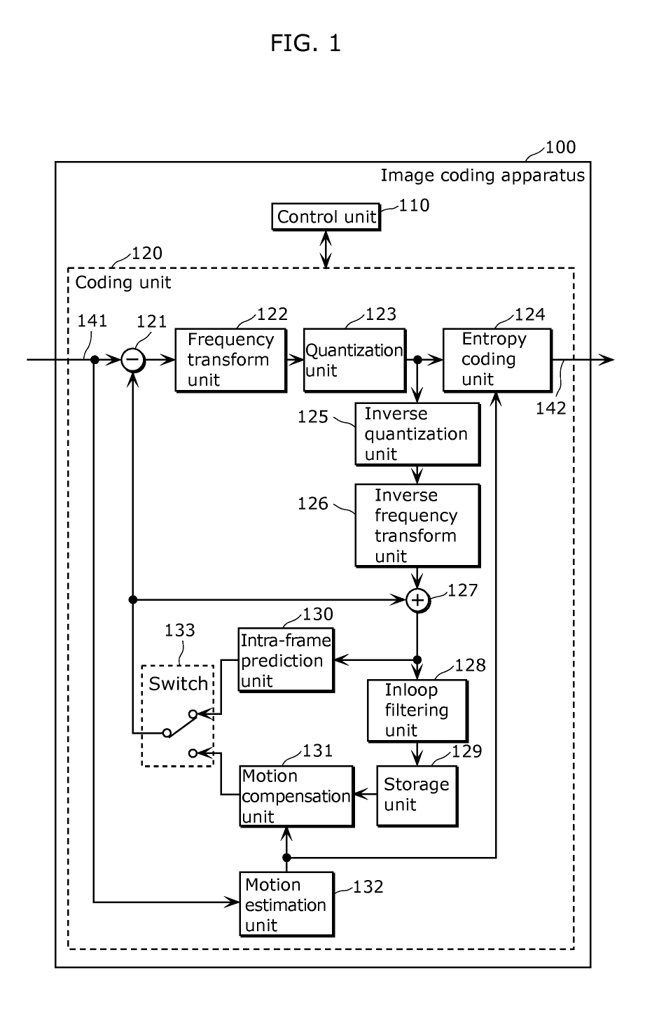

FIG. 1 shows a structure of an image coding apparatus according to the HEVC standard.

An image coding apparatus 100 shown in FIG. 1 includes a control unit 110 and a coding unit 120. The coding unit 120 includes a subtraction unit 121, a frequency transform unit 122, a quantization unit 123, an entropy coding unit 124, an inverse quantization unit 125, an inverse frequency transform unit 126, an addition unit 127, an inloop filtering unit 129, a storage unit 129, an intra-frame prediction unit 130, a motion compensation unit 131, a motion estimation unit 132, and a switch 133.

As shown in FIG. 1, the coding unit 120 codes, on a per-block basis, an image inputted (an input image) 141, to generate a coded stream 142. At this time, the subtraction unit 121 of the coding unit 120 subtracts a pixel block made up of a plurality of pixel values in a prediction image, from a pixel block made up of a plurality of pixel values of an image 141. The frequency transform unit 122 transforms a pixel block resulting from the subtraction, into a coefficient block made up of a plurality of frequency coefficients. The quantization unit 123 quantizes the coefficient block obtained by the frequency transform unit 122.

Meanwhile, the motion estimation unit 132 estimates a motion vector using the pixel block of the image 141. The motion compensation unit 131 generates a prediction image by performing inter-frame prediction (inter prediction) using a reference image stored in the storage unit 129 and a motion vector estimated by the motion estimation unit 132. The intra-frame prediction unit 130 generates a prediction image by performing, according to an intra-frame prediction mode, intra-frame prediction (intra prediction) using a pixel block obtained by the addition unit 127. The switch 133 outputs, to the subtraction unit 121 and the addition unit 127, a pixel block of the prediction image generated by the intra-frame prediction unit 130 or the motion compensation unit 131.

The entropy coding unit 124 generates the coded stream 142 by performing entropy coding on block partition information, a type of prediction, a motion vector, a prediction mode (an intra-frame prediction mode), a quantization parameter, a quantized coefficient block, and so on.

The inverse quantization unit 125 inversely quantizes a quantized coefficient block. Subsequently, the inverse frequency transform unit 126 transforms the inversely quantized coefficient block into a pixel block. The addition unit 127 then adds the pixel block of the prediction image to the pixel block obtained by the inverse frequency transform unit 126. The inloop filtering unit 128 performs block artifact cancellation and input-image-based difference correction on a pixel block obtained by the addition unit 127, and stores a resultant pixel block into the storage unit 129 as a reference image.

Furthermore, the control unit 110 controls the coding unit 120.

The image coding apparatus 100 codes the image 141 by the above-described operation. In addition, the image coding apparatus 100 allows for a reduction in the data amount of the coded stream 142 through various processes such as frequency transform, quantization, intra-frame prediction, inter-frame prediction, entropy coding, and inloop filtering.

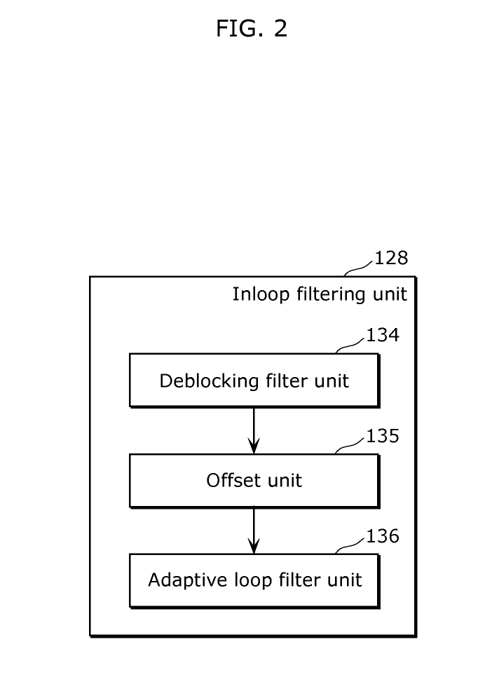

FIG. 2 shows a structure of the inloop filtering unit 128 in the image coding apparatus 100 shown in FIG. 1.

The inloop filtering unit 128 includes, as shown in FIG. 2, a deblocking filter unit 134, an offset unit 135, and an adaptive loop filter unit 136.

The deblocking filter unit 134 performs low pass filtering on pixels on a block boundary of the pixel block (the decoded image) obtained by the addition unit 127, in order to remove, from the block boundary, artifacts (block artifacts) generated when a coding process is performed on a per-block basis. Next, the offset unit 135 classifies, into a plurality of classes, pixels within a current block to be processed which results from the low pass filtering in the deblocking filter unit 134, and adds, for each of the classes, an offset value for correcting a difference from the input image. Next, the adaptive loop filter unit 136 performs, on the current block resulting from the addition of the offset value in the offset unit 135, a filtering process using a low pass filter adapted to a feature of a current pixel to be processed, in order to remove noise generated in the coding process.

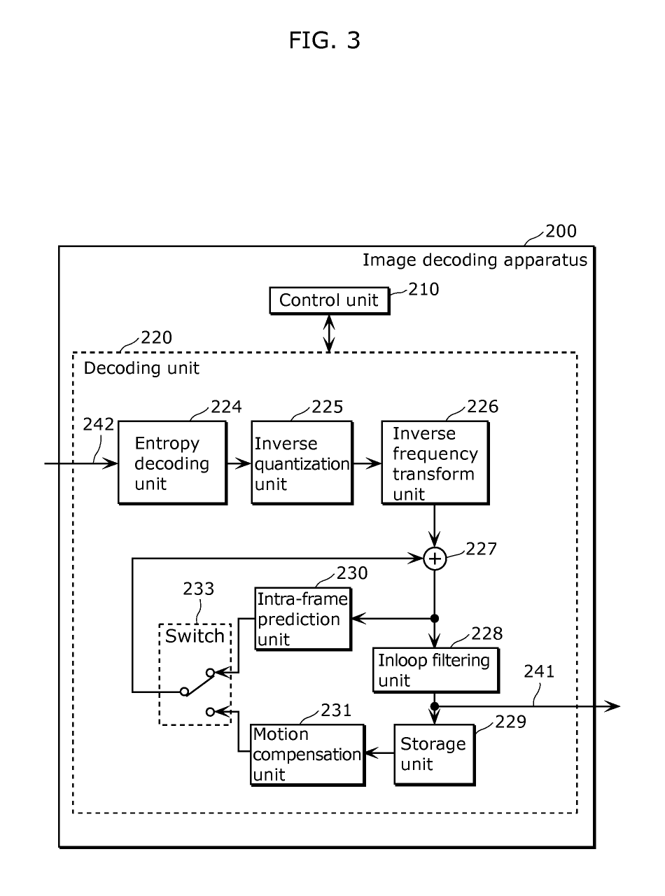

FIG. 3 shows a structure of an image decoding apparatus corresponding to the image coding apparatus 100 shown in FIG. 1.

An image decoding apparatus 200 shown in FIG. 3 includes a control unit 210 and a decoding unit 220. The decoding unit 220 includes an entropy decoding unit 224, an inverse quantization unit 225, an inverse frequency transform unit 226, an addition unit 227, an inloop filtering unit 228, a storage unit 229, an intra-frame prediction unit 230, a motion compensation unit 231, and a switch 233.

As shown in FIG. 3, the decoding unit 220 decodes, on a per-block basis, an image 241 included in the coded stream 242. At this time, the entropy decoding unit 224 of the decoding unit 220 performs entropy decoding on the coded stream 242, to obtain block partition information, a type of prediction, a motion vector, an intra-frame prediction mode, a quantization parameter, a quantized coefficient block, a pixel classification method for the case of offset (sample adaptive offset abbreviated as SAO), an offset value, and so on.

Furthermore, the control unit 210 controls the operation of the decoding unit 220.

The inverse quantization unit 225 of the decoding unit 220 inversely quantizes a quantized coefficient block. The inverse frequency transform unit 226 transforms the inversely quantized coefficient block into a pixel block.

The addition unit 227 then adds the pixel block of the prediction image to the pixel block obtained by the inverse frequency transform unit 226. The inloop filtering unit 228 performs, on a pixel block obtained by the addition unit 227, block artifact cancellation, difference correction based on the coding-side input image, and so on. Afterward, the inloop filtering unit 228 stores a resultant pixel block into the storage unit 229 as a reference image. Furthermore, the inloop filtering unit 228 outputs the image 241 made up of pixel blocks.

When the type of prediction is intra-frame prediction, the intra-frame prediction unit 230 generates a prediction image by performing, according to an intra-frame prediction mode, the intra-frame prediction using the pixel block obtained by the addition unit 227. When the type of prediction is inter-frame prediction, the motion compensation unit 231 generates a prediction image by performing inter-frame prediction using the motion vector and the reference image stored in the storage unit 229. The switch 233 outputs, to the addition unit 227, a pixel block of the prediction image generated by the intra-frame prediction unit 230 or the motion compensation unit 231.

As above, the image decoding apparatus 200 decodes, on a per-block basis, the image 241 included in the coded stream 242, by the operation corresponding to the image coding apparatus 100.

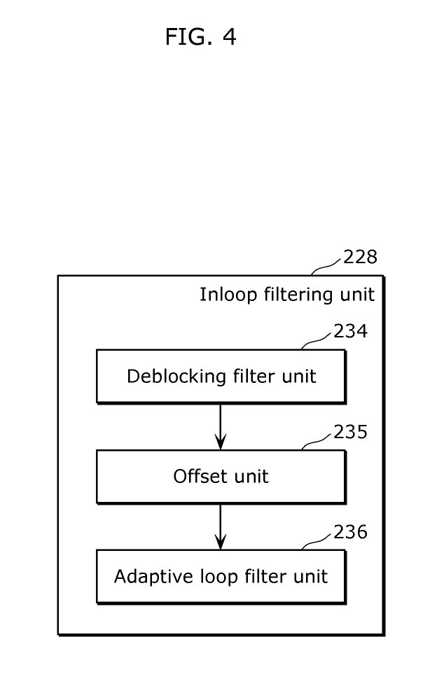

FIG. 4 shows a structure of the inloop filtering unit 228 in the image decoding apparatus 200 shown in FIG. 3.

The inloop filtering unit 228 includes, as shown in FIG. 4, a deblocking filter unit 234, an offset unit 235, and an adaptive loop filter unit 236. The deblocking filter unit 234 performs low pass filtering on pixels on a block boundary of the pixel block (the decoded image) obtained by the addition unit 227, in order to remove, from the block boundary, artifacts (block artifacts) generated when a coding process is performed on a per-block basis. Next, the offset unit 235 classifies, into a plurality of classes, pixels within a current block resulting from the low pass filtering in the deblocking filter unit 234, and adds, for each of the classes, an offset value for correcting a difference from the input image. Next, the adaptive loop filter unit 236 performs, on the current block resulting from the addition of the offset value in the offset unit 235, a filtering process using a low pass filter adapted to a feature of a current pixel, in order to remove noise generated in the coding process.

Here, in the image coding scheme represented by the HEVC standard, the sample adaptive offset (SAO) process included in the inloop filtering process is described in more detail.

The SAO process is performed to classify, into a plurality of classes, the pixels included in the current block resulting from the deblocking filtering. Furthermore, for each of the classes, an offset value that is an average value of differences between the input image and the deblocking-filtered image has been coded, and the offset value is added to the deblocking-filtered image, to correct the differences from the input image.

The classification of pixels in the SAO process roughly includes two methods: the edge offset and the band offset. The edge offset mainly improves the coding efficiency for a current block which includes many edge parts. On the other hand, the band offset mainly improves the coding efficiency for a current block which includes many flat parts.

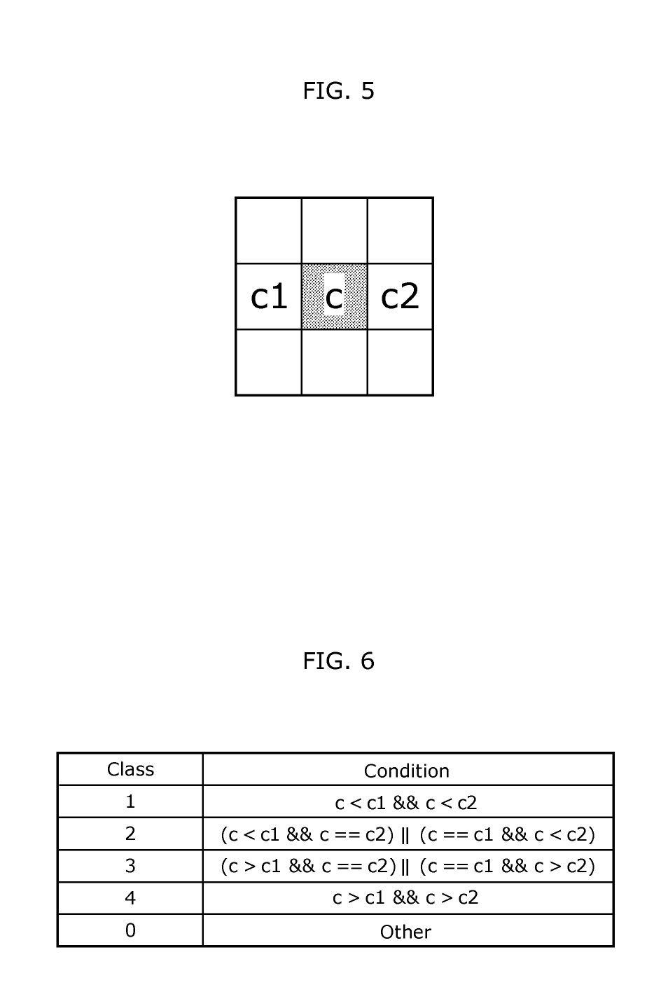

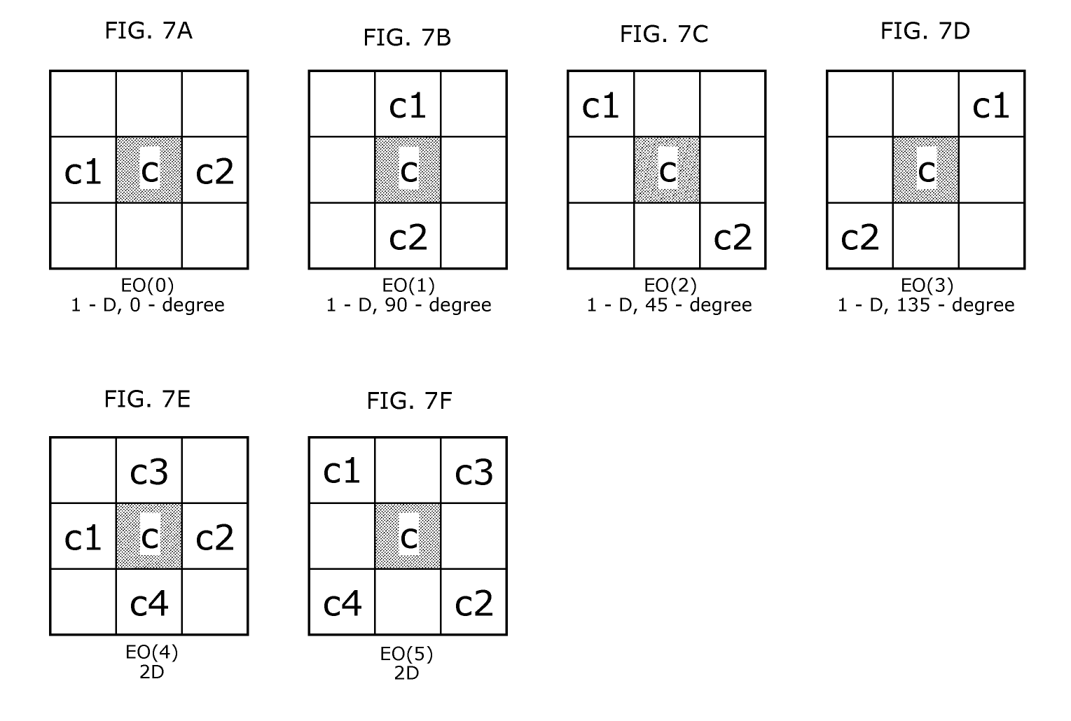

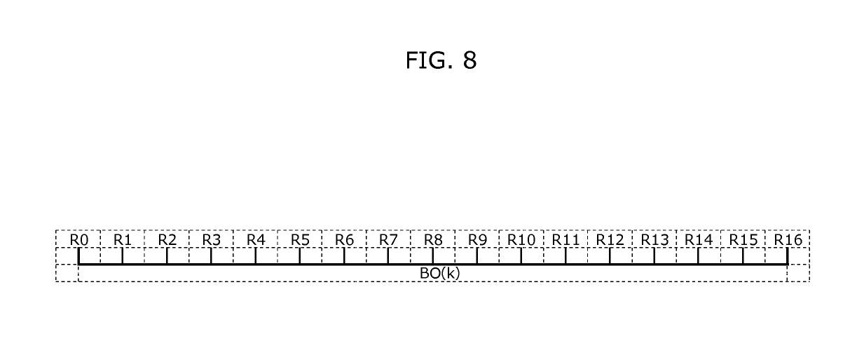

FIG. 5 schematically shows an example of the edge offset pixel classification method. In the edge offset, the classification is performed according to the pixel value relationship between a current pixel c and adjacent pixels c1 and c2 located to the left and the right of the current pixel c. FIG. 6 schematically shows an example in which the current block is classified into five classes by the edge offset. For example, when the pixel value of the current pixel c is greater than the pixel value of the adjacent pixel c1 and is equal to the pixel value of the adjacent pixel c2, the current pixel is classified as Class 3, and the offset value Offset [3] assigned to Class 3 is added to the pixel value of the current pixel. Furthermore, in the edge offset, an adjacent pixel which is compared to the current pixel may be, other than right and left adjacent pixels (EO(0)) shown in FIG. 7A as in FIG. 5, upper and lower adjacent pixels (EOM) shown in FIG. 7B, oblique adjacent pixels (EO(2) or EO(3)) shown in FIGS. 7C and 7D, or combinations thereof (EO(4) or EO(5)) shown in FIGS. 7E and 7F.

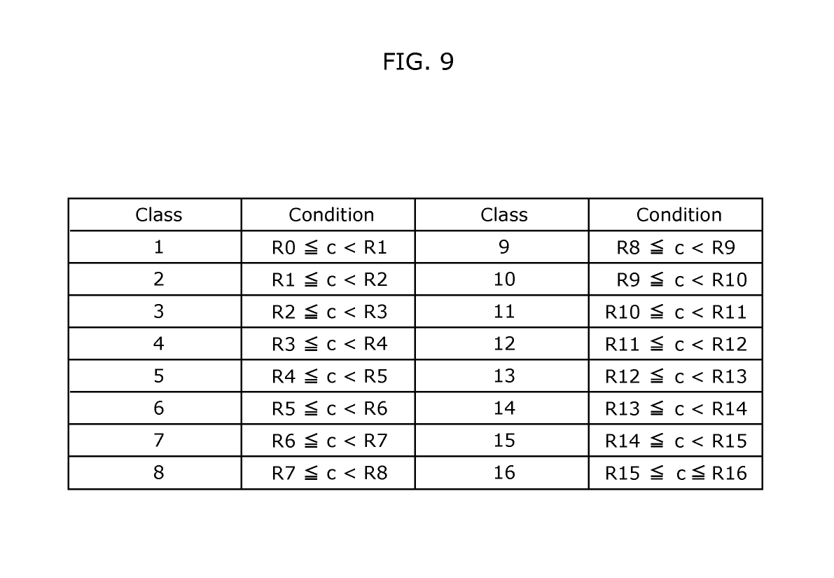

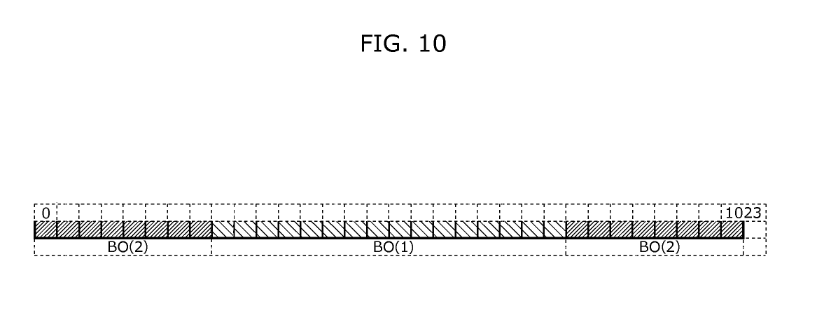

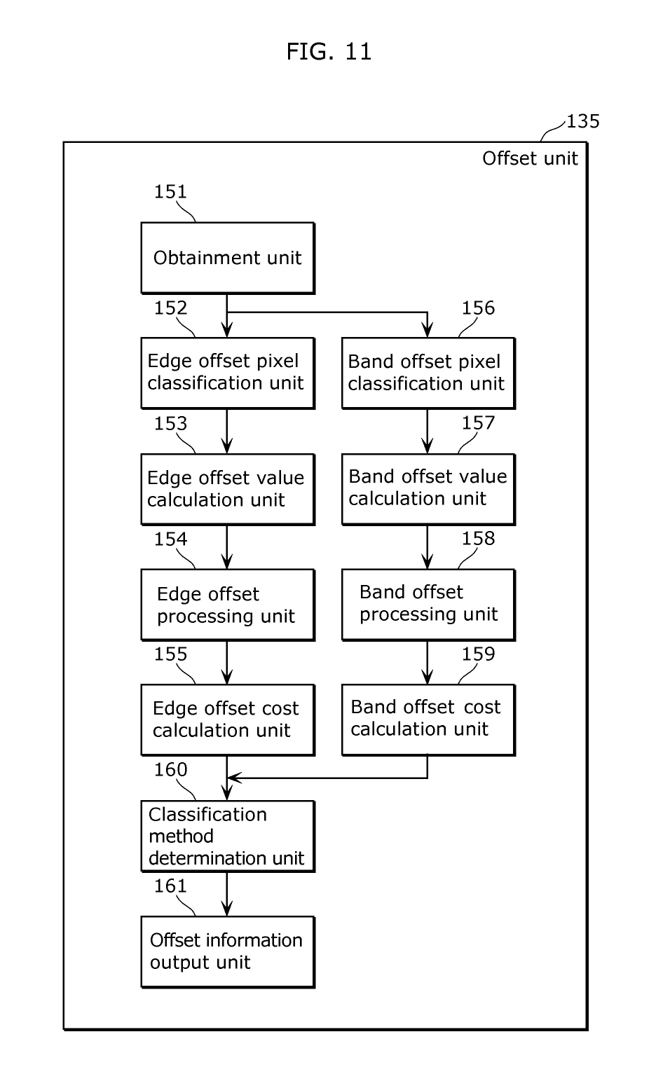

FIG. 8 schematically shows an example of the band offset pixel classification method. In the band offset, a current pixel resulting from the deblocking filtering is classified first based on its pixel value. As shown in FIG. 8, possible tone levels of the pixel value of the current pixel are equally divided into M. M is 16, for example. The unit of resultant tone level section is referred to as a band. The current pixel is classified as a class which corresponds to the band in which the pixel value of the current pixel is included. FIG. 9 schematically shows an example of class conditions for use in classifying the pixels of the current block into 16 classes by the band offset. For example, when the pixel value of the current pixel c is greater than or equal to R9 and less than R10, the current pixel is classified as Class 10. The offset value Offset [109] assigned to Class 10 is then added to the pixel value of the current pixel c. Furthermore, the tone levels subject to the band offset process are limited to remove redundancy of coding an offset value in a tone level which is not included in the current block. For example, the HEVC test model in Non patent Literature 3, the tone levels from “0” to “1023” are equally divided into 32 bands when the SAO process is performed with 10-bit accuracy as shown in FIG. 10. This means that one band has 32 tone levels. There is a classification method for 16 bands in the middle tone levels only (BO(0)) or a classification method for 8 bands at each end other than the middle tone levels, i.e., 16 bands in total (BO(1)).

Furthermore, in the image coding method represented by the HEVC standard, each current pixel is classified by six classification methods: the edge offset EO(0) to EO(3) and BO(0) to BO(1), for example, before the offset process is performed. On the results of the offset process by these six classification methods, RD optimization using a cost function for evaluating an image quality and a bit amount is performed. Subsequently, information indicating one of the six classification methods for which the cost function value is smallest, and a corresponding offset value are coded.

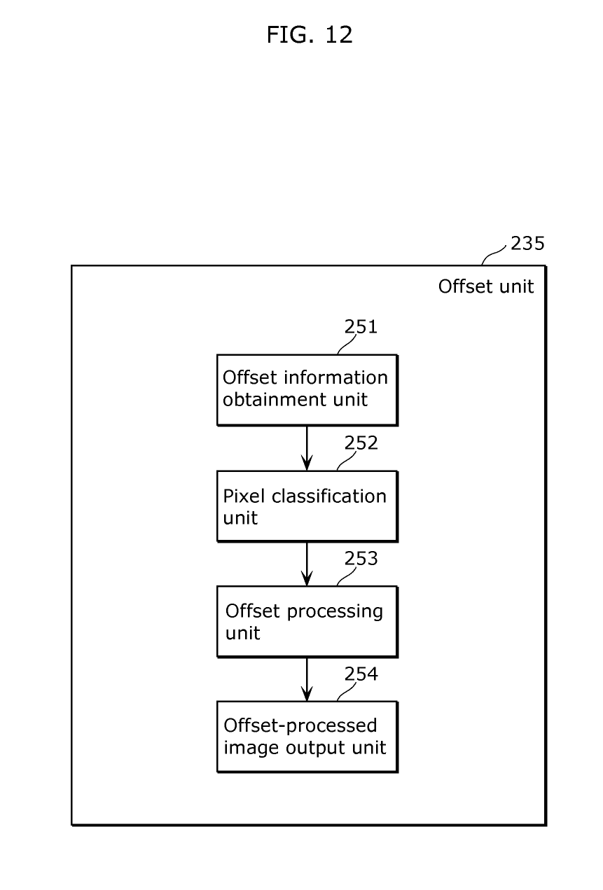

FIG. 11 is a block diagram showing an example of a structure of the offset unit 135 in the image coding apparatus according to the HEVC standard.

The offset unit 135 includes an obtainment unit 151, an edge offset pixel classification unit 152, an edge offset value calculation unit 153, an edge offset processing unit 154, an edge offset cost calculation unit 155, a band offset pixel classification unit 156, a band offset value calculation unit 157, a band offset processing unit 158, a band offset cost calculation unit 159, a classification method determination unit 160, and an offset information output unit 161.

The obtainment unit 151 obtains the deblocking-filtered image from the deblocking filter unit 134 shown in FIG. 2. The edge offset pixel classification unit 152 compares the values of the current pixel and its adjacent pixels and classifies the current pixel as one of the classes based on the designated classification method. The edge offset value calculation unit 153 calculates, for each of the classes into which the respective pixels of the current block are classified, an average of differences between the pixel values of the input image and the pixel values of the deblocking-filtered image. This average of differences becomes an offset value. In other words, the offset value is calculated for each of the classes of the current block. The edge offset processing unit 154 adds the offset value to the pixel value of the deblocking-filtered image for each of the classes. The edge offset cost calculation unit 155 calculates a cost of the edge offset-type offset process using a cost function which includes a difference between the input image and the offset-processed image and a bit amount of offset information (the pixel classification method and the offset value). The band offset pixel classification unit 156 classifies the current pixel as one of the classes according to the pixel value of the current pixel based on the designated classification method. The band offset value calculation unit 157 calculates, for each of the classes into which the respective pixels of the current block are classified, an average of differences between the pixel values of the input image and the pixel values of the deblocking-filtered image. This average of differences becomes an offset value. As in the above, the offset value is calculated for each of the classes of the current block. The band offset processing unit 158 adds the offset value to the pixel value of the deblocking-filtered image for each of the classes. The band offset cost calculation unit 159 calculates a cost of the band offset-type offset process using a cost function which includes a difference between the input image and the offset-processed image and a bit amount of offset information (the pixel classification method and the offset value). The classification method determination unit 160 compares the costs calculated using the edge offset and band offset classification methods and thereby determines, as the optimum classification method, the classification method for which the cost is lowest. The offset information output unit 161 outputs, to the entropy coding unit 124 shown in FIG. 1, the optimum classification method and the offset value calculated using the optimum classification method. Furthermore, the offset information output unit 161 outputs the offset-processed image to the adaptive loop filter unit 136 shown in FIG. 2.

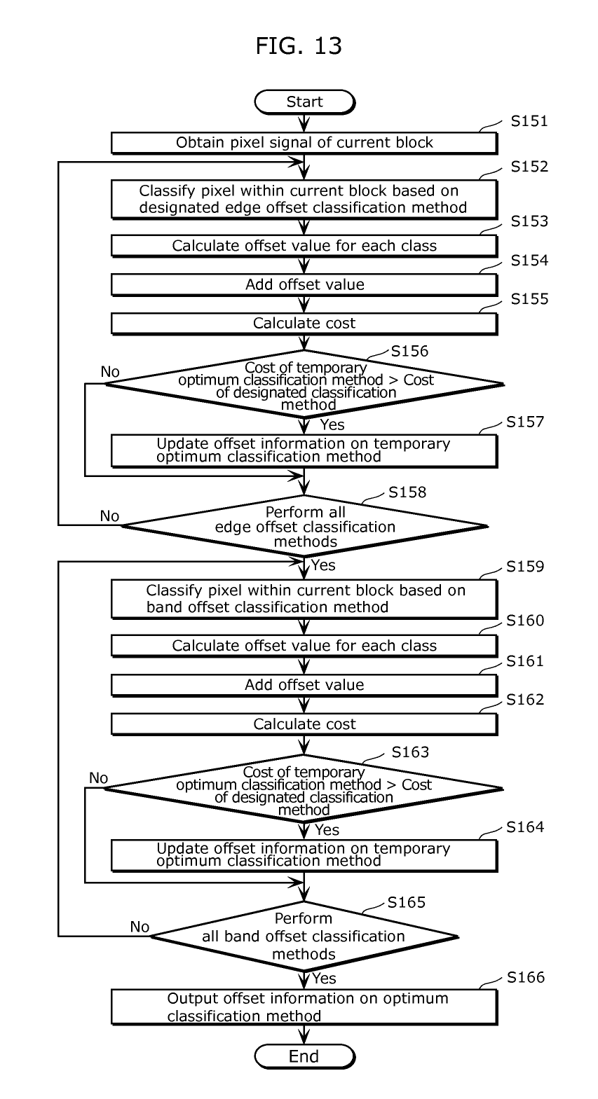

FIG. 12 is a block diagram showing an example of a structure of the offset unit 235 in an image decoding apparatus which corresponds to the image coding apparatus shown in FIG. 11 according to the HEVC standard.

The offset unit 235 includes an offset information obtainment unit 251, a pixel classification unit 252, an offset processing unit 253, and an offset-processed image output unit 254. The offset information obtainment unit 251 obtains the deblocking-filtered image and the offset information (the pixel classification method and the offset value) from the deblocking filter unit 234 shown in FIG. 4 and the entropy decoding unit 224 shown in FIG. 3, respectively. The pixel classification unit 252 classifies each of the pixels of the current block as one of the classes based on the pixel classification method in the obtained offset information. The offset processing unit 253 adds the offset value to the pixel value of the deblocking-filtered image for each of the classes. The offset-processed image output unit 254 outputs the offset-processed image of the current block to the adaptive loop filter unit 236 shown in FIG. 4.

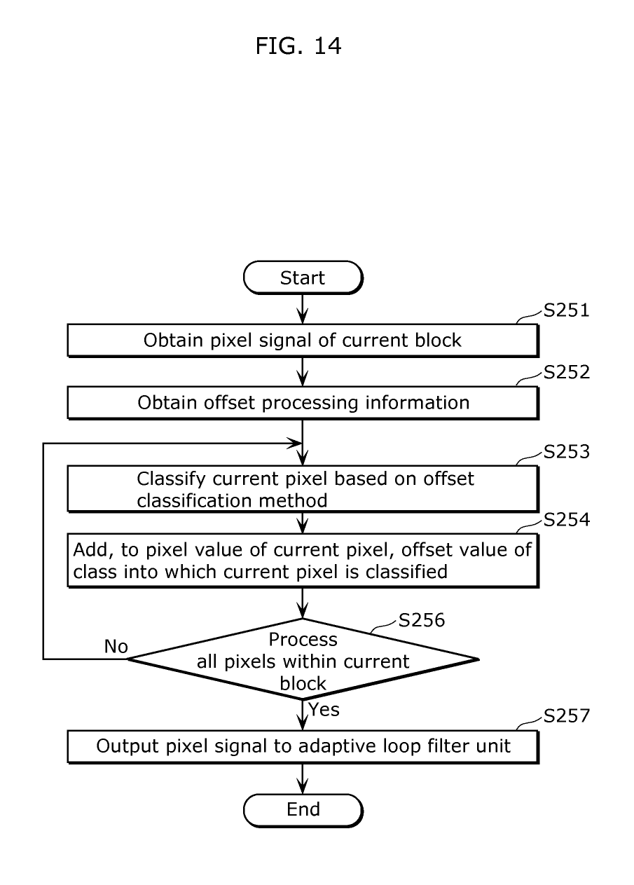

FIG. 13 is a flowchart showing an operation of the offset unit 135 in the image coding apparatus 100 shown in FIG. 11.

First, the obtainment unit 151 obtains the deblocking-filtered image from the deblocking filter unit 134 (S151).

Next, the edge offset pixel classification unit 152 calculates the values of the current pixel and its adjacent pixels and classifies the current pixel as one of the classes, based on the designated classification method among the edge offset classification methods. This classification is then performed for each of the pixels within the current block so that the pixels within the current block are classified into corresponding classes (S152).

Next, the edge offset value calculation unit 153 calculates, for each of the classes, the average of differences between the pixel values of the input image and the pixel values of the deblocking-filtered image (S153). This becomes the offset value of each of the classes.

Next, the edge offset processing unit 154 adds the offset value to the pixel value of the deblocking-filtered image for each of the classes (S154).

Next, the edge offset cost calculation unit 155 calculates the cost of the designated classification method using the cost function which includes a difference between the input image and the offset-processed image and the bit amount of the offset information (S155). Here, the offset information is the offset value of each of the classes and an index number indicating the designated classification method. The bit amount is an amount of bits which are generated when the offset information is coded.

Next, the classification method determination unit 160 determines whether or not the cost of the designated classification method is less than the cost of a temporary optimum classification method which is lowest in cost among the past classification methods (S156). When the cost of the designated classification method is determined to be not less than the cost of the temporary optimum classification method (No in S156), no processing is performed.

On the other hand, when the cost of the designated classification method is less than the cost of the temporary optimum classification method (Yes in S156), the classification method determination unit 160 updates the offset information on the temporary optimum classification method to the offset information on the designated classification method (S157).

Next, the classification method determination unit 160 determines whether or not the offset processes based on all the edge offset classification methods have been performed (S158). When it is determined that not the offset processes based on all the edge offset classification methods have been performed (No in S158), the processing from the classification (S152) to the updating (S157) is repeated.

On the other hand, when the offset processes based on all the edge offset classification methods have been performed (Yes in S158), the band offset pixel classification unit 156 calculates a band including the pixel value of the current pixel and classifies the current pixel as one of the classes, based on the designated classification method among the band offset classification methods. This classification is then performed for each of the pixels within the current block so that the pixels within the current block are classified into corresponding classes (S159).

Next, the band offset value calculation unit 157 calculates, for each of the classes, an average of differences between the pixel values of the input image and the pixel values of the deblocking-filtered image (S160). This becomes the offset value of each of the classes.

Next, the band offset processing unit 158 adds the offset value to the pixel value of the deblocking-filtered image for each of the classes (S161).

Next, the band offset cost calculation unit 159 calculates the cost of the designated classification method using the cost function which includes a difference between the input image and the offset-processed image and the bit amount of the offset information (S162). Here, the offset information is the offset value of each of the classes and an index number indicating the designated classification method. The bit amount is an amount of bits which are generated when the offset information is coded.

Next, the classification method determination unit 160 determines whether or not the cost of the designated classification method is less than the cost of a temporary optimum classification method which is lowest in cost among the past classification methods (S163). When the cost of the designated classification method is determined to be not less than the cost of the temporary optimum classification method (No in S163), no processing is performed.

On the other hand, when the cost of the designated classification method is less than the cost of the temporary optimum classification method (Yes in S163), the classification method determination unit 160 updates the offset information on the temporary optimum classification method to the offset information on the designated classification method (S164).

Next, the classification method determination unit 160 determines whether or not the offset processes based on all the band offset classification methods have been performed (S165). When it is determined that not the offset processes based on all the band offset classification methods have been performed (No in S165), the processing from the classification (S159) to the updating (S164) is repeated.

On the other hand, when the offset processes based on all the band offset classification methods have been performed (Yes in S165), the offset information output unit 161 outputs the offset information on the optimum classification method to the entropy coding unit 124 (S166).

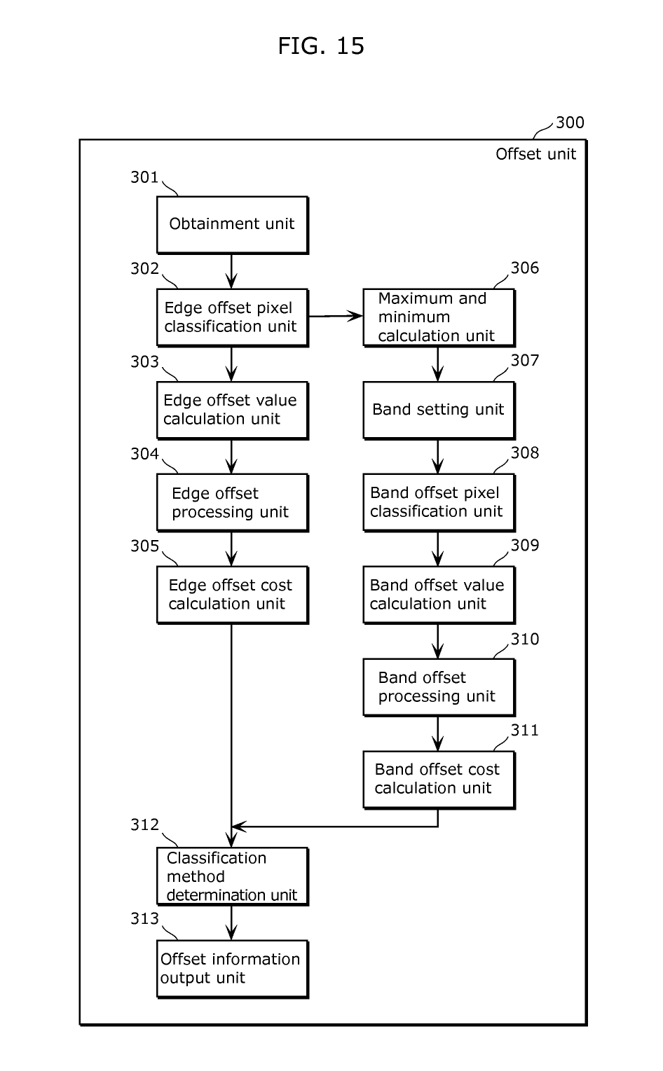

FIG. 14 is a flowchart showing an operation of the offset unit 235 in the image coding apparatus 200 shown in FIG. 12.

First, the offset information obtainment unit 251 obtains the deblocking-filtered image from the deblocking filter unit 134 (S251).

Next, the offset information obtainment unit 251 obtains the offset information decoded by the entropy decoding unit 224 (S252). Here, the offset information includes the pixel classification method and the offset value of each of the classes.

Next, the pixel classification unit 252 classifies the current pixel as one of the classes based on the obtained offset classification method (S253).

Next, the offset processing unit 253 adds, to the pixel value of the current pixel, the offset value of the class into which the current pixel is classified (S254).

Next, the offset processing unit 253 determines whether or not all the pixels within the current block have been processed (S256). When it is determined that not all the pixels within the current block have been processed (No in S256), the processing from the classification (S254) to the addition (S255) is repeated.

On the other hand, when all the pixels within the current block have been processed (Yes in S256), the offset-processed image output unit 254 outputs the offset-processed image of the current block to the adaptive loop filter unit 236.

This makes it possible to generate a decoded image close to the input image while reducing an increase in the bit amount.

However, in the above technique, the number of bands and the width of each band are always fixed in the band offset. Accordingly, when the pixel values within the current block are largely biased as is often seen in especially a chroma signal, the coding efficiency may not be sufficiently high.

In order to achieve the above object, an image coding method according to an aspect of the present disclosure is an image coding method for coding an input image on a per-block basis, the method comprising: obtaining a decoded image generated by decoding a coded image resulting from coding of the input image; setting at least one band to be variable on a per-block basis among a plurality of bands obtained by dividing possible tone levels of a pixel value of the decoded image into predetermined tone level sections, the band being subject to an offset process; performing band offset pixel classification to classify, as one of classes, each pixel included in a current block to be processed in the decoded image, based on whether or not the pixel is included in the band which is set in the setting; calculating a band offset value for each of the classes, the band offset value being an offset value that is an average of differences between pixel values of the input image and pixel values of the decoded image for the pixel classified as the class; and performing a band offset process of adding the offset value to the pixel value of the decoded image for each of the classes, for the pixel classified as the class.

By doing so, the band subject to the band offset is adaptively changed so that the coding of the offset value is no longer necessary for a band in which no pixel value is present or a very few pixel values are present, with the result that the bit amount can be reduced for redundant offset values. This means that the coding efficiency at the time of applying the band offset can be improved.

Furthermore, the image coding method may further comprise outputting (i) an offset-processed image resulting from the offset process which involves the addition of the offset value in the performing of a band offset process and (ii) information which is used in the offset process.

Furthermore, it may be that the image coding method further comprises calculating a maximum and a minimum of the pixel values of the decoded image, wherein in the setting, the band is set to be variable on a per-block basis, based on the maximum and the minimum calculated in the calculating of a maximum and a minimum.

Furthermore, it may be that the calculating of a maximum and a minimum includes calculating the maximum and the minimum of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction.

Furthermore, it may be that further in the setting, at least one of a total number of the bands and a width of each of the bands is set to be variable on a per-block basis, based on the maximum and the minimum calculated in the calculating of a maximum and a minimum.

Furthermore, it may be that the image coding method further comprises calculating a histogram of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction, wherein in the setting, the band is set to be variable on a per-block basis, based on the histogram.

Furthermore, it may be that further in the setting, at least one of a total number of the bands and a width of each of the bands is set to be variable on a per-block basis, based on the histogram.

Furthermore, the image coding method may further comprise: performing edge offset pixel classification to classify a pixel of the decoded image as one of classes based on an edge offset pixel classification method; calculating an edge offset value for each of the classes, the edge offset value being an offset value that is an average of differences between pixel values of the input image and pixel values of the decoded image; performing an edge offset process of adding the offset value to a pixel value of the decoded image for each of the classes; calculating a cost of the edge offset pixel classification method using a difference between the input image and an offset-processed image and a code amount of information necessary for an offset process; calculating a cost of a band offset pixel classification method using a difference between the input image and an offset-processed image and a code amount of information necessary for the offset process; determining an optimum pixel classification method by selecting a minimum cost from among respective costs of a plurality of edge offset pixel classification methods and respective costs of a plurality of band offset pixel classification methods including the cost of the edge offset pixel classification method and the cost of the band offset pixel classification method; and outputting (i) an offset-processed image resulting from an offset process in the optimum pixel classification method and (ii) information which is used in the offset process.

An image decoding method according to an aspect of the present disclosure is an image decoding method for decoding a coded stream on a per-block basis, the method comprising: obtaining a decoded image generated by decoding the coded stream, and obtaining information which is included in the coded stream and is used in an offset process; setting at least one band to be variable on a per-block basis among a plurality of bands obtained by dividing possible tone levels of a pixel value of the decoded image into predetermined tone level sections, the band being subject to the offset process; performing band offset pixel classification to classify, as one of classes, each pixel included in a current block to be processed in the decoded image, based on whether or not the pixel is included in the band which is set in the setting; performing a band offset process of adding an offset value to the pixel value of the decoded image for each of the classes, the offset value being included in the information which is obtained in the obtaining and is used in the offset process; and outputting an offset-processed image resulting from the addition of the offset value.

By doing so, the band subject to the band offset is adaptively changed so that the decoding of the offset value is no longer necessary for a band in which no pixel value is present or a very few pixel values are present, with the result that the bit amount can be reduced for redundant offset values.

Furthermore, it may be that in the setting, the block is set to be variable on a per-block basis, based on the information which is obtained in the obtaining and is used in the offset process.

Furthermore, it may be that the image decoding method comprises calculating a maximum and a minimum of pixel values of the decoded image, wherein in the setting, the band is set to be variable on a per-block basis, based on the maximum and the minimum calculated in the calculating of a maximum and a minimum.

Furthermore, it may be that the calculating of a maximum and a minimum includes calculating the maximum and the minimum of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction.

Furthermore, it may be that further in the setting, at least one of a total number of the bands and a width of each of the bands is set to be variable on a per-block basis, based on the maximum and the minimum calculated in the calculating of a maximum and a minimum.

Furthermore, it may be that the image decoding method further comprises calculating a histogram of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction, wherein in the setting, the band is set to be variable on a per-block basis, based on the histogram.

Furthermore, it may be that further in the setting, at least one of a total number of the bands and a width of each of the bands is set to be variable on a per-block basis, based on the histogram.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Embodiments in the present disclosure are described in detail below with reference to the drawings.

Each of the embodiments described below shows a general or specific example. The numerical values, shapes, materials, structural elements, the arrangement and connection of the structural elements, steps, the order of the steps etc. shown in the following embodiments are examples, and therefore do not limit the scope of Claims. Therefore, among the structural elements in the following embodiments, structural elements not recited in any one of the independent claims defining the most generic part of the inventive concept are described as arbitrary structural elements.

### Embodiment 1

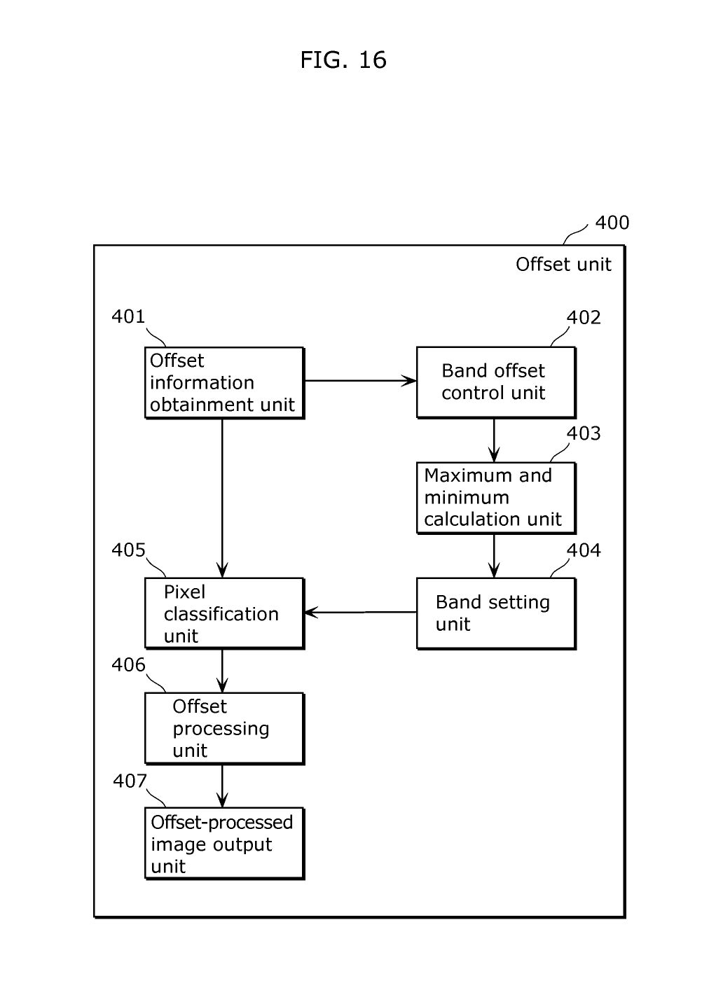

A structure of an offset unit 300 in inloop filtering in an image coding apparatus according to this embodiment is described. FIG. 15 is a block diagram showing an example of the structure of the offset unit 300 in the image coding apparatus according to this embodiment. As will be described later, the offset unit 300 according to Embodiment 1 in the present disclosure corresponds to a part of the image coding apparatus 100 which compresses and codes an image signal and outputs coded image data.

The offset unit 300 includes an obtainment unit 301, an edge offset pixel classification unit 302, an edge offset value calculation unit 303, an edge offset processing unit 304, an edge offset cost calculation unit 305, a maximum and minimum calculation unit 306, a band setting unit 307, a band offset pixel classification unit 308, a band offset value calculation unit 309, a band offset processing unit 310, a band offset cost calculation unit 311, a classification method determination unit 312, and an offset information output unit 313. Of these, the maximum and minimum calculation unit 306 and the band setting unit 307 may be included in the control unit 110 of FIG. 1, for example.

The obtainment unit 301 obtains the deblocking-filtered image from the deblocking filter unit 134 shown in FIG. 2. The edge offset pixel classification unit 302 compares the values of the current pixel and its adjacent pixels based on the designated classification method and classifies the current pixel as one of the classes. The edge offset value calculation unit 303 calculates, for each of the classes into which the respective pixels of the current block are classified, an average of differences between the pixel values of the input image and the pixel values of the deblocking-filtered image. This average of differences becomes an offset value. In other words, the offset value is calculated for each of the classes of the current block. The edge offset processing unit 304 adds the offset value to the pixel value of the deblocking-filtered image for each of the classes. The edge offset cost calculation unit 305 calculates a cost of the edge offset-type offset process using a cost function which includes a difference between the input image and the offset-processed image and a bit amount of offset information (the pixel classification method and the offset value).

The maximum and minimum calculation unit 306 calculates the maximum and the minimum of the pixel values of the deblocking-filtered image of the current block obtained by the obtainment unit 301. The band setting unit 307 sets the number of bands and the width of each band based on the minimum and the maximum calculated in the maximum and minimum calculation unit 306. The band offset pixel classification unit 308 classifies the current pixel as one of the classes according to the pixel value of the current pixel based on the designated classification method. The band offset value calculation unit 309 calculates, for each of the classes into which the respective pixels of the current block are classified, an average of differences between the pixel values of the input image and the pixel values of the deblocking-filtered image. This average of differences becomes an offset value. As in the above, the offset value is calculated for each of the classes of the current block. The band offset processing unit 310 adds the offset value to the pixel value of the deblocking-filtered image for each of the classes. The band offset cost calculation unit 311 calculates a cost of the band offset-type offset process using a cost function which includes a difference between the input image and the offset-processed image and a bit amount of offset information (the pixel classification method and the offset value).

The classification method determination unit 312 compares the costs calculated using the edge offset and band offset classification methods and thereby determines, as the optimum classification method, the classification method for which the cost is lowest. The offset information output unit 313 outputs, to the entropy coding unit 124 shown in FIG. 1, the optimum classification method and the offset value calculated using the optimum classification method. Furthermore, the offset information output unit 161 outputs the offset-processed image to the adaptive loop filter unit 136 shown in FIG. 2.

The above offset unit 300 is different from the offset unit 135 shown in FIG. 11 in that the maximum and minimum calculation unit 306 and the band setting unit 307 are provided.

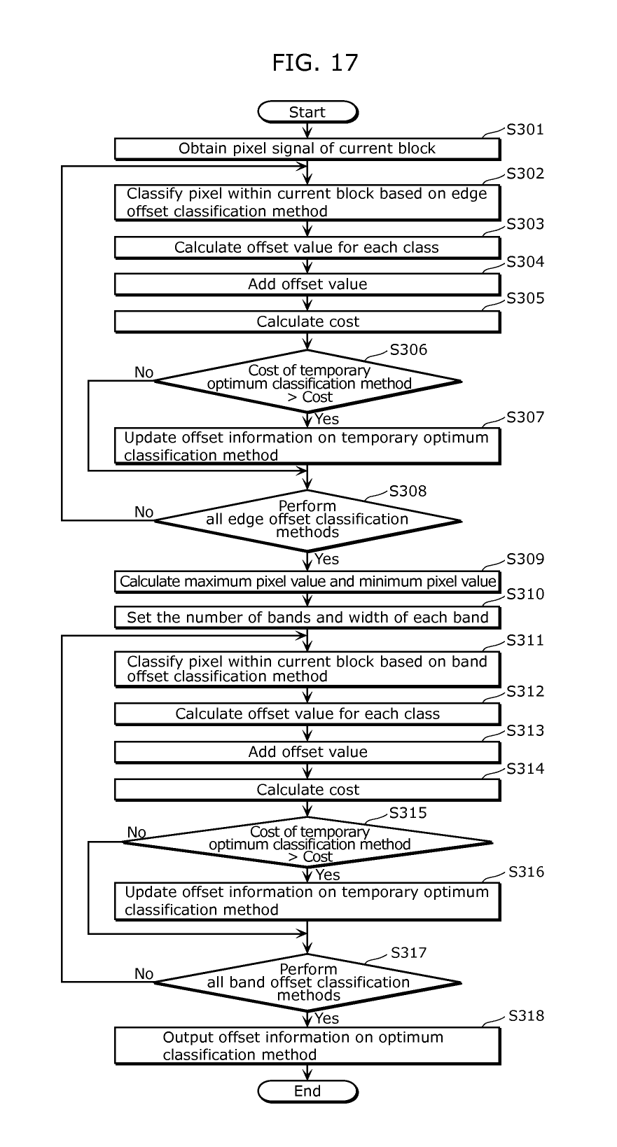

FIG. 16 is a block diagram showing an example of a structure of an offset unit 400 in an image decoding apparatus corresponding to the image coding apparatus according to this embodiment. As will be described later, the offset unit 400 according to Embodiment 1 in the present disclosure corresponds to a part of the image decoding apparatus 200 which decodes a coded signal and outputs decoded image data.

The offset unit 400 includes an offset information obtainment unit 401, a band offset control unit 402, a maximum and minimum calculation unit 403, a band setting unit 404, a pixel classification unit 405, an offset processing unit 406, and an offset-processed image output unit 407. Of these, the band offset control unit 402, the maximum and minimum calculation unit 403, and the band setting unit 404 may be included in the control unit 210 of FIG. 3, for example.

The offset information obtainment unit 401 obtains the deblocking-filtered image and the offset information (the pixel classification method and the offset value) from the deblocking filter unit 234 shown in FIG. 4 and the entropy decoding unit 224 shown in FIG. 3, respectively. The band offset control unit 402 determines whether or not the band offset is performed, by referring to the pixel classification method in the offset information obtained by the offset information obtainment unit 401. The maximum and minimum calculation unit 403 calculates the maximum and the minimum of the pixel values of the deblocking-filtered image of the current block obtained by the offset information obtainment unit 401. The band setting unit 407 sets the number of bands and the width of each band based on the minimum and the maximum calculated in the maximum and minimum calculation unit 402. The pixel classification unit 405 classifies each of the pixels of the current block as one of the classes based on the pixel classification method in the offset information obtained by the offset information obtainment unit 401. The offset processing unit 406 adds the offset value to the pixel value of the deblocking-filtered image for each of the classes. The offset-processed image output unit 407 outputs the offset-processed image of the current block to the adaptive loop filter unit 236 shown in FIG. 4.

The above offset unit 400 is different from a conventional structure example of the offset unit 235 shown in FIG. 12 in that the band offset control unit 402, the maximum and minimum calculation unit 403, and the band setting unit 404 are provided.

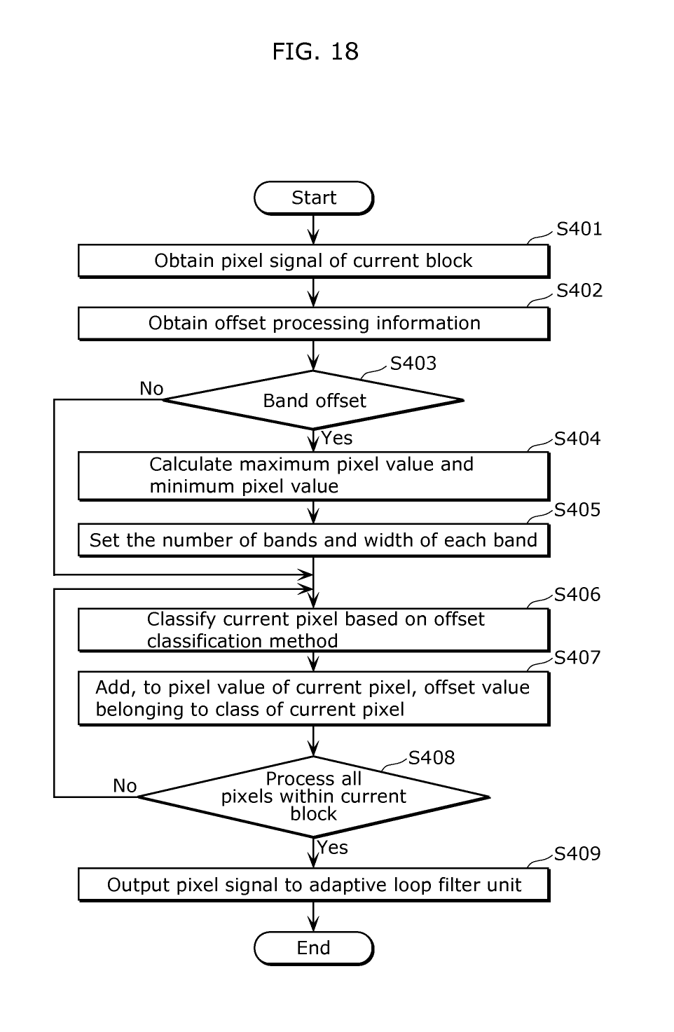

FIG. 17 is a flowchart showing an operation of the offset unit 300 in the image coding apparatus shown in FIG. 15.

First, the obtainment unit 301 obtains the deblocking-filtered image from the deblocking filter unit 134 (S301).

Next, the edge offset pixel classification unit 302 calculates the values of the current pixel and its adjacent pixels based on the designated classification method among the edge offset classification methods, and classifies the current pixel as one of the classes. This classification is then performed for each of the pixels within the current block so that the pixels within the current block are classified into corresponding classes (S302).

Next, the edge offset value calculation unit 303 calculates, for each of the classes, an average of differences between the pixel values of the input image and the pixel values of the deblocking-filtered image (S303). This becomes the offset value of each of the classes.

Next, the edge offset processing unit 304 adds the offset value to the pixel value of the deblocking-filtered image for each of the classes (S304).

Next, the edge offset cost calculation unit 305 calculates the cost of the designated classification method using the cost function which includes a difference between the input image and the offset-processed image and the bit amount of the offset information (S305). Here, the offset information is the offset value of each of the classes and an index number indicating the designated classification method. The bit amount is an amount of bits which are generated when the offset information is coded.

Next, the classification method determination unit 312 determines whether or not the cost of the designated classification method is less than the cost of a temporary optimum classification method which is lowest in cost among the past classification methods (S306). When the cost of the designated classification method is determined to be not less than the cost of the temporary optimum classification method (No in S306), no processing is performed.

On the other hand, when the cost of the designated classification method is less than the cost of the temporary optimum classification method (Yes in S306), the classification method determination unit 312 updates the offset information on the temporary optimum classification method to the offset information on the designated classification method (S307).

Next, the classification method determination unit 312 determines whether or not the offset processes based on all the edge offset classification methods have been performed (S308). When it is determined that not the offset processes based on all the edge offset classification methods have been performed (No in S308), the processing from the classification (S302) to the updating (S307) is repeated.

On the other hand, when the offset processes based on all the edge offset classification methods have been performed (Yes in S308), the maximum and minimum classification unit 306 calculates the maximum and the minimum of the pixel values of the deblocking-filtered image of the current block (S309).

Next, the band setting unit 307 sets the number of bands and the width of each band based on the minimum and the maximum calculated in the maximum and minimum calculation unit 306 (S310).

Next, the band offset pixel classification unit 308 calculates a band including the pixel value of the current pixel and classifies the current pixel as one of the classes, based on the designated classification method among the band offset classification methods. This classification is then performed for each of the pixels within the current block so that the pixels within the current block are classified into corresponding classes (S311).

Next, the band offset value calculation unit 309 calculates, for each of the classes, an average of differences between the pixel values of the input image and the pixel values of the deblocking-filtered image (S312). This becomes the offset value of each of the classes.

Next, the band offset processing unit 310 adds the offset value to the pixel value of the deblocking-filtered image for each of the classes (S313).

Next, the band offset cost calculation unit 311 calculates the cost of the designated classification method using the cost function which includes a difference between the input image and the offset-processed image and the bit amount of the offset information (S314). Here, the offset information is the offset value of each of the classes and an index number indicating the designated classification method. The bit amount is an amount of bits which are generated when the offset information is coded.

Next, the classification method determination unit 312 determines whether or not the cost of the designated classification method is less than the cost of a temporary optimum classification method which is lowest in cost among the past classification methods (S315). When the cost of the designated classification method is determined to be not less than the cost of the temporary optimum classification method (No in S315), no processing is performed.

On the other hand, when the cost of the designated classification method is less than the cost of the temporary optimum classification method (Yes in S315), the classification method determination unit 312 updates the offset information on the temporary optimum classification method to the offset information on the designated classification method (S316).

Next, the classification method determination unit 312 determines whether or not the offset processes based on all the band offset classification methods have been performed (S317). When it is determined that not the offset processes based on all the band offset classification methods have been performed (No in S317), the processing from the classification (S311) to the updating (S316) is repeated.

On the other hand, when the offset processes based on all the band offset classification methods have been performed (Yes in S317), the offset information output unit 313 outputs the offset information on the optimum classification method to the entropy coding unit 124 (S318).

Thus, by adaptively changing the number of bands and the width of each band in the band offset according to the degree of bias of the pixel values within the current block, the coding of the offset value is no longer necessary for a band in which no pixel value is present or a very few pixel values are present, with the result that the bit amount can be reduced for redundant offset values. Furthermore, it is possible to change the number of bands and the width of each band without inserting new information to the bitstream. This means that the offset unit 300 is capable of improving the coding efficiency at the time of applying the band offset.

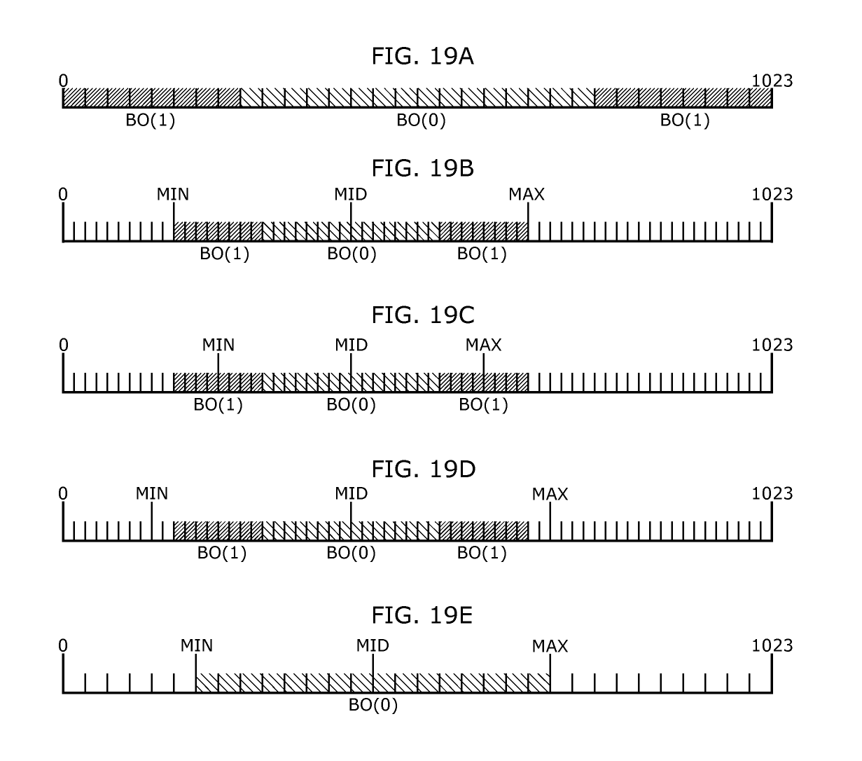

FIG. 18 is a flowchart showing an operation of the offset unit 400 in the image decoding apparatus shown in FIG. 16.

First, the offset information obtainment unit 401 obtains the deblocking-filtered image from the deblocking filter unit 234 (S401).

Next, the offset information obtainment unit 401 obtains the offset information decoded by the entropy decoding unit 224 (S402). Here, the offset information includes the pixel classification method and the offset value of each of the classes.

Next, the band offset control unit 402 determines whether or not the pixel classification method is the band offset, by referring to the pixel classification method in the offset information obtained by the offset information obtainment unit 401 (S403). When it is determined that the pixel classification method is the band offset (Yes in S403), the maximum and minimum calculation unit 403 calculates the maximum and the minimum of the pixel values of the deblocking-filtered image of the current block (S404).

Next, the band setting unit 404 sets the number of bands and the width of each band based on the minimum and the maximum calculated in the maximum and minimum calculation unit 403 (S405).

Next, the pixel classification unit 405 classifies the current pixel as one of the classes based on the offset classification method obtained by the offset information obtainment unit 401 (S406).

Next, the offset processing unit 406 adds, to the pixel value of the current pixel, the offset value of the class into which the current pixel is classified (S407).

Next, the offset processing unit 406 determines whether or not all the pixels within the current block have been processed (S408). When it is determined that not all the pixels within the current block have been processed (No in S408), the processing from the classification (S406) to the addition (S407) is repeated.

On the other hand, when all the pixels within the current block have been processed (Yes in S408), the offset-processed image output unit 407 outputs the offset-processed image of the current block to the adaptive loop filter unit 236 (S409).

Thus, by adaptively changing the number of bands and the width of each band in the band offset according to the degree of bias of the pixel values within the current block, the decoding of the offset value is no longer necessary for a band in which no pixel value is present or a very few pixel values are present, with the result that the bit amount can be reduced for redundant offset values. Furthermore, it is possible to change the number of bands and the width of each band without obtaining new information from the bitstream. This means that, as in the case of the offset unit 300, the offset unit 400 is capable of improving the coding efficiency at the time of applying the band offset.

Here, the setting of the number of bands and the width of each band in the band setting unit 307 and the band setting unit 404 is described in detail.

In this embodiment, the number of bands and the width of each band are set using the maximum MAX and the minimum MIN of the pixel values of the deblocking-filtered image of the current block calculated by the maximum and minimum calculation unit 306 or the maximum and minimum calculation unit 403.

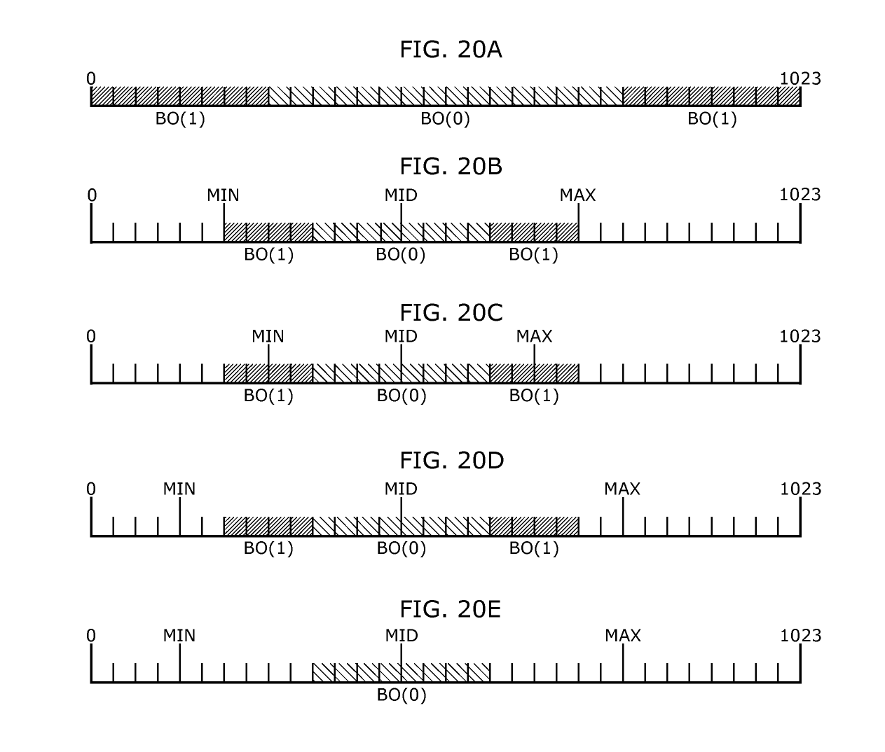

First, an example where the number of bands is fixed at 32 which is the same as above is described. Specifically, a band width Range is variable. FIG. 19A schematically shows fixed bands. FIGS. 19B, 19C, and 19D schematically show examples in this embodiment where the width of each band is variable. The number of bands and the width of each band are both integers, which means that the tone levels from MIN to MAX cannot simply be divided by 32. The case as shown in FIG. 19B where the bands are set to fall within MIN to MAX is rare. There are also cases as shown in FIG. 19C where the bands are set in the tone levels outside the range of MIN to MAX and cases as shown in FIG. 19D where the bands which do not cover the whole range of MIN to MAX are set.

Therefore, the band width Range is calculated using Expression (1).

Range=((MAX−MIN+1)>>5)+1 (1)

Next, the mid-value MID of subject tone levels is calculated using Expression (2).

MID=MAX+MIN>>2 (2)

Next, 16 bands each having the width Range are set on either side of the mid-value MID as shown in FIGS. 19B to 19D.

This makes it possible to remove, as compared to the case of FIG. 19A, redundancy of performing the offset process on a band in which no pixel value is present in the deblocking-filtered image of the current block.

It may also be possible to set bands as shown in FIG. 19E so that one classification method is used. This allows for a reduction in memory usage for the classification method BO(1) in the offset unit 300.

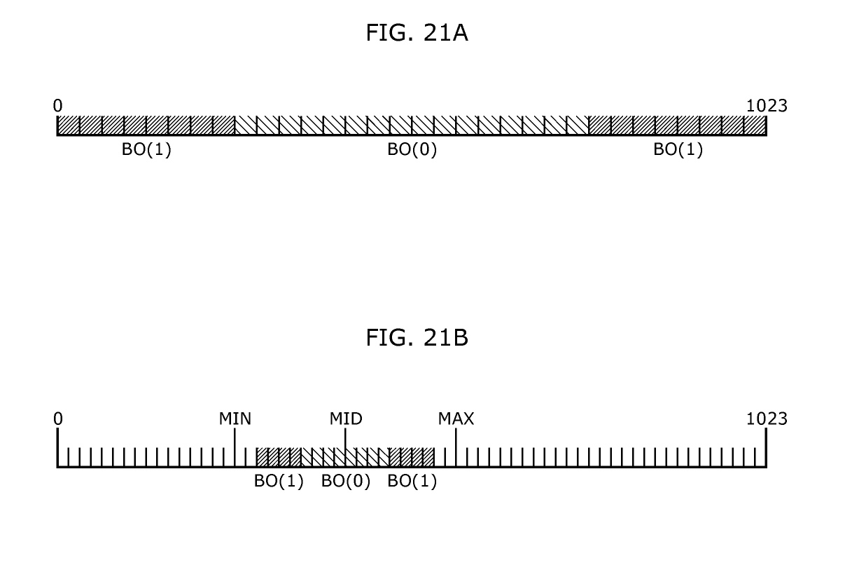

Next, an example where the width of each band is fixed at 32 which is the same as above is described. Specifically, the number of bands NumBand is variable. FIG. 20A schematically shows fixed bands. FIGS. 20B, 20C, and 20D schematically show examples in this embodiment where the number of bands is variable. As in the case where the number of bands is fixed, the number of bands and the width of each band are both integers, which means that the tone levels from MIN to MAX cannot simply be divided by 8. The case as shown in FIG. 20B where the bands are set to fall within MIN to MAX is rare. There are also cases as shown in FIG. 20C where the bands are set in the tone levels outside the range of MIN to MAX and cases as shown in FIG. 20D where the bands which do not cover the whole range of MIN to MAX are set.

Therefore, the number of bands NumBand is calculated using Expression (3).

NumBand=(((MAX−MIN+1)>>3)>>2)+1)<<2 (3)

Next, the mid-value MID2 of subject tone levels is calculated using Expression (4).

MID2=MAX+MIN>>2 (4)

Next, NumBand/2 bands each having the width 32 are set on either side of the mid-value MID2 as shown in FIGS. 20B to 20D.

This makes it possible to remove, as compared to the case of FIG. 20A, redundancy of performing the offset process on a band in which no pixel value is present in the deblocking-filtered image of the current block.

It may also be possible to set bands as shown in FIG. 20E so that one classification method is used. This allows for a reduction in memory usage for the classification method BO(1) in the offset unit 300.

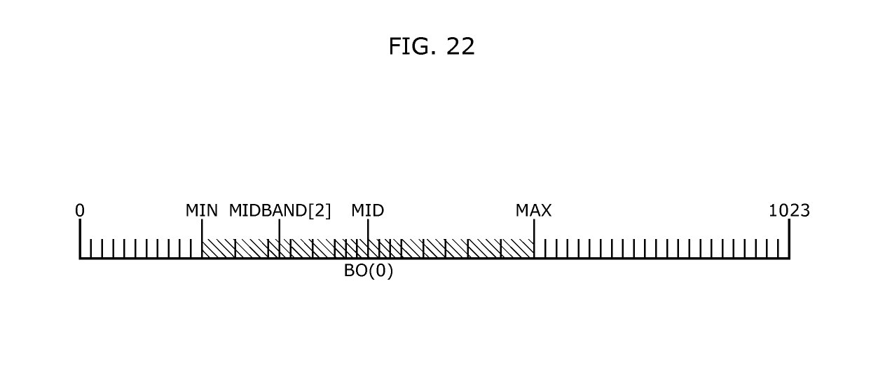

Furthermore, both of the number of bands and the width of each band may be variable. FIG. 21A schematically shows fixed bands. FIG. 21B schematically shows an example in this embodiment where both the number of bands and the width of each band are variable.

In this case, since the number of bands NumBand and the width of each band Range cannot be calculated using Expression (1) and Expression (3), respectively, a table is used which indicates the relationship between the maximum MAX, the minimum MIN, the number of bands NumBand, and the width of each band Range.

By doing so, it becomes possible to more efficiently set bands for the pixel values in the deblocking-filtered image of the current block.

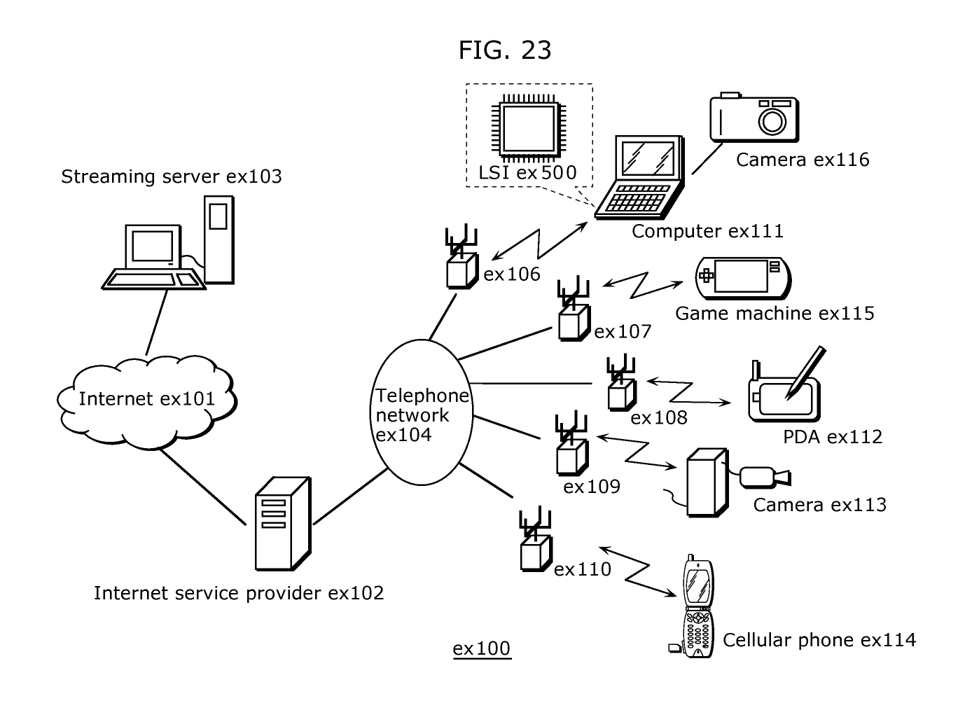

It may also be possible to set bands with different widths. FIG. 22 schematically shows an example in this embodiment where bands with different widths are set.

First, the mid-value MID3 of subject tone levels is calculated using Expression (5).

MID3=MAX+MIN>>2 (5)

Next, assuming that the mid-value of the X-th band is MIDBAND[X] where 0≦X≦15, the width of the band is reduced as in Expression (6) using arbitrary threshold values Th1 and Th2.

if (|MIDBAND[X] − MID| ≦ Th1)

Range = R

else if (|MIDBAND[X] − MID| ≦ Th2)

Range = R << 1

else

| | |
|---|---|
| Range = R << 2 | (6) |

By doing so, it becomes possible to more efficiently set bands for the pixel values in the deblocking-filtered image of the current block.

Although the above describes the example in which the width of the band changes in three stages using two threshold values, this is not a restrictive example.

Furthermore, the numerical values which are set as the number of bands and the width of each band are each preferably a power of 2, but are not restrictive.

Furthermore, although the maximum MAX and the minimum MIN used for setting bands are calculated from the pixel values of the deblocking-filtered image of the current block, the maximum MAX and the minimum MIN may be calculated from a block located above the current block, a block located to the left of the current block, the blocks located above and to the left of the current block, an immediately previous slice, an immediately previous frame, an immediately previous I-frame, or a reference block in the inter-frame prediction.

This eliminates the need of waiting for the process of comparing the values of all the pixels within the current block, which allows the processing delay of pixel classification to be overcome.

Furthermore, instead of the maximum MAX and the minimum MIN, a histogram of the current pixel value may be used.

By doing so, it becomes possible to more efficiently set bands by setting bands with small widths in high tone levels while setting bands with large widths in low tone levels.

Furthermore, both the band offset classification method using fixed bands and the band offset classification method in this embodiment using variable bands may be applied to classify the pixels to determine the optimum pixel classification method.

This makes it possible to further improve the coding efficiency in the band offset.

Furthermore, instead of the bands being variable in number, in width, and in number and width as described above, it may be that the positions of the bands which are fixed in number and width are variable. In other words, the band to which the band offset is applied is variable. In this case, the band setting unit 307 and the band setting unit 404 do not need to set the number of bands and the width of each band based on the minimum and the maximum calculated by the maximum and minimum calculation unit 306 or the maximum and minimum calculation unit 402. The band setting unit 307 and the band setting unit 404 set the positions of bands using a preset number of bands and a preset width of each band, for example. Furthermore, the band setting unit 307 and the band setting unit 404 may set the positions of bands based on the minimum and the maximum calculated by the maximum and minimum calculation unit 306 or the maximum and minimum calculation unit 402, for example. Alternatively, the band setting unit 307 and the band setting unit 404 may set the positions of bands by calculating costs, for example. Moreover, in the case where the minimum and the maximum are not used, the offset unit 300 does not need to include the maximum and minimum calculation unit 306, and the offset unit 400 does not need to include the maximum and minimum calculation unit 402.

Furthermore, although the offset information output unit 313 outputs the offset information (the pixel classification method and the offset value) to the entropy coding unit 124 as the information which is used in the offset process in this embodiment, this is not a restrictive example. For example, the offset information output unit 313 may output information indicating the position of a band to which the band offset is applied, to the entropy coding unit 124 as the information which is used in the offset process.

Although the image coding apparatus and the image decoding apparatus according to the present disclosure have been described above based on the embodiments, the present disclosure is not limited to these embodiments. The present disclosure includes various variations of the embodiments which will occur to those skilled in the art, and other embodiments in which structural elements of different embodiments are combined.

For example, processing which is executed by a particular processing unit may be executed by another processing unit. Furthermore, the order to execute processes may be changed, and a plurality of processes may be executed in parallel. Furthermore, a dedicated or shared storage unit for storing various information items may be added to the structure.

Furthermore, the present disclosure can be implemented not only as the image coding apparatus and the image decoding apparatus, but also as a method which includes, as steps, the processing units included in each of the image coding apparatus and the image decoding apparatus. For example, these steps are executed by a computer. In addition, the present disclosure can be implemented as a program which causes a computer to execute these steps included in the method. Furthermore, the present disclosure can be implemented as a non-transitory computer-readable recording medium such as a compact disc read-only memory (CD-ROM) on which the program has been recorded.

A plurality of structural elements included in the image coding apparatus and the image decoding apparatus may be implemented as a large scale integration (LSI) that is an integrated circuit. These structural elements may be each provided on a single chip, and part or all of them may be formed into a single chip. For example the structural elements other than the storage unit may be formed into a signal chip. The name used here is LSI, but it may also be called an integrated circuit (IC), system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed, or a reconfigurable processor that allows re-configuration of the connection or configuration of an LSI may be used.

Furthermore, if, with advancement in semiconductor technology or its derivations, a brand-new technology for integrated circuits which replaces LSI appears, it is, of course, possible to use such technology to integrate the structural elements included in the image coding apparatus and the image decoding apparatus.

### Embodiment 2

The processing described in the above embodiment can be simply implemented in an independent computer system, by recording, in a recording medium, a program for implementing the configurations of the moving picture coding method and the moving picture decoding method described in the above embodiment. The recording media may be any recording media as long as the program can be recorded, such as a magnetic disk, an optical disk, a magnetic optical disk, an IC card, and a semiconductor memory.

Hereinafter, the applications to the moving picture coding method (the image coding method) and the moving picture decoding method (the image decoding method) described in the above embodiment and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

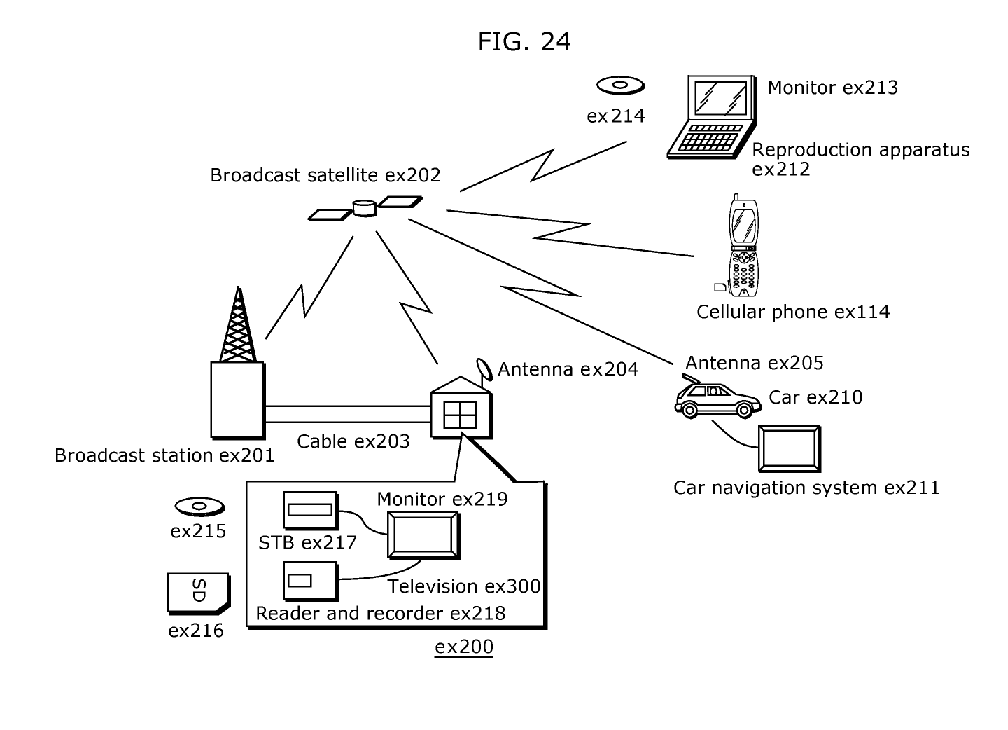

FIG. 23 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 23, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, content (for example, video of a music live show) captured by the user using the camera ex113 is coded as described above in the above embodiment (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

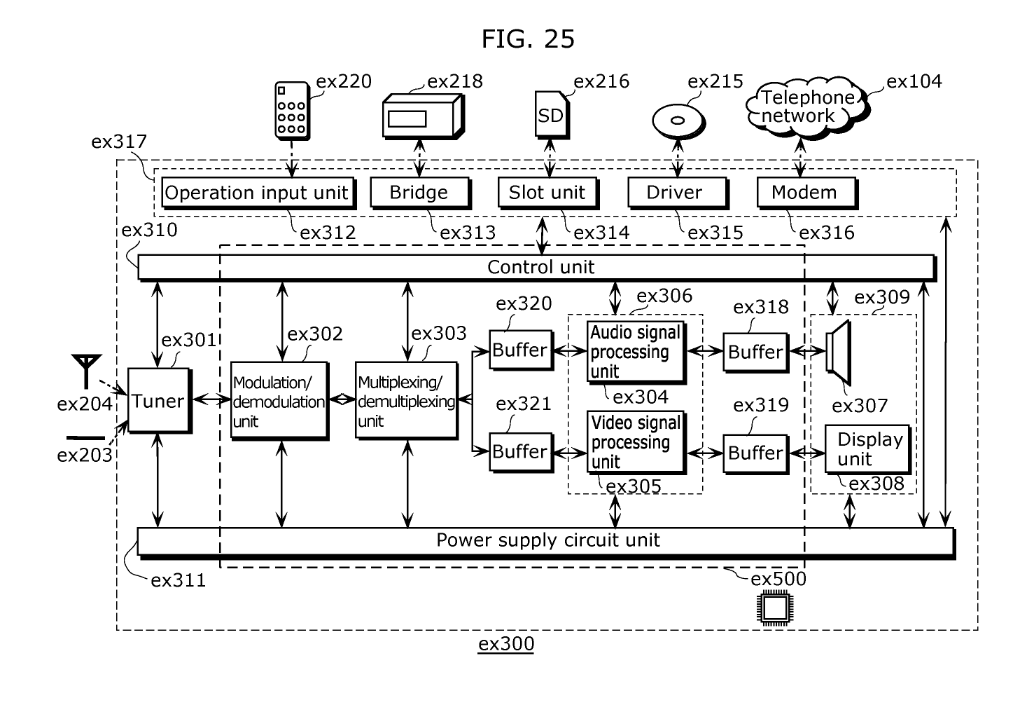

Aside from the example of the content providing system ex100, at least one of the moving picture coding apparatus (the image coding apparatus) and the moving picture decoding apparatus (the image decoding apparatus) described in the above embodiment may be implemented in a digital broadcasting system ex200 illustrated in FIG. 24. More specifically, a broadcast station ex201 communicates or transmits, via radio waves to a broadcast satellite ex202, multiplexed data obtained by multiplexing audio data and others onto video data. The video data is data coded by the moving picture coding method described in the above embodiment (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (ii) codes video signals in the recording medium ex215, and in some cases, writes data obtained by multiplexing an audio signal on the coded data. The reader/recorder ex218 can include the moving picture decoding apparatus or the moving picture coding apparatus as shown in the above embodiment. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

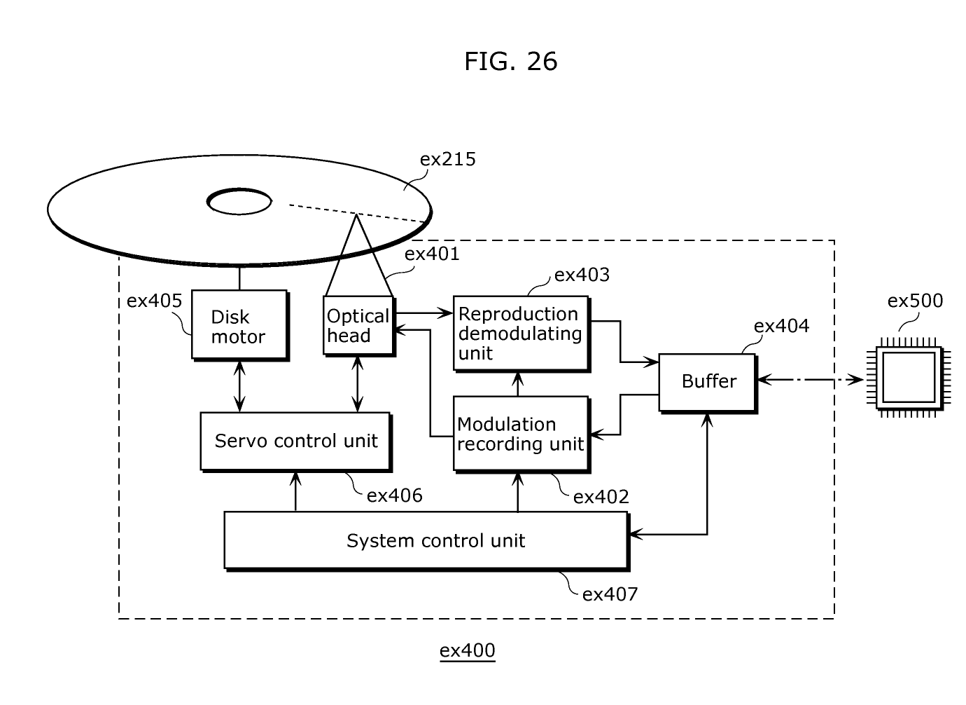

FIG. 25 illustrates the television (receiver) ex300 that uses the moving picture coding method and the moving picture decoding method described in the above embodiment. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in the above embodiment, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in the above embodiment. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

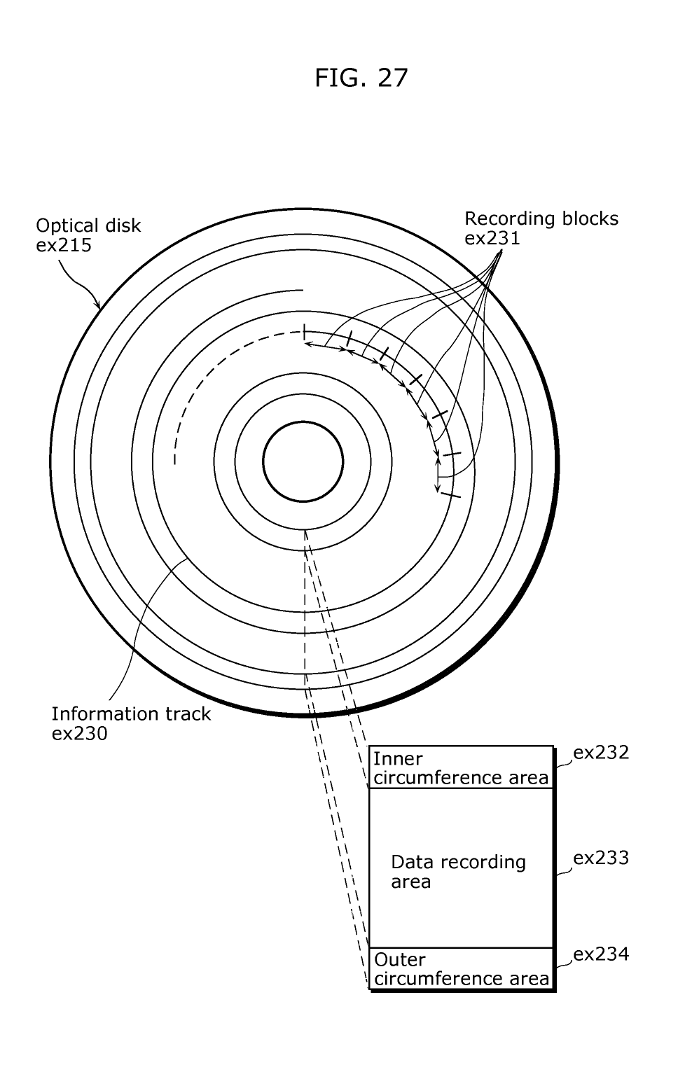

As an example, FIG. 26 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

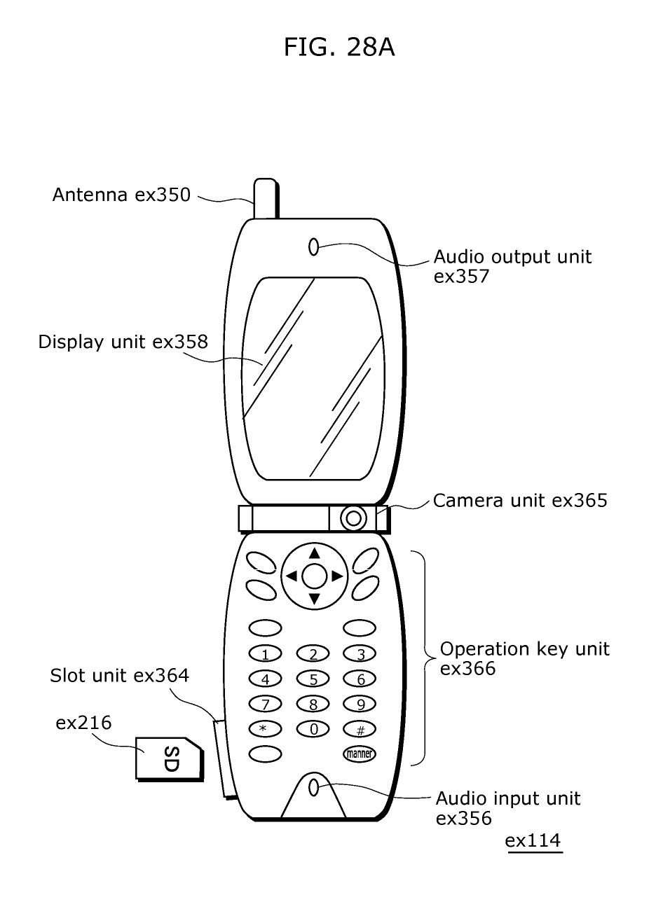

FIG. 27 schematically illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 25. The same will be true for the configuration of the computer ex111, the cellular phone ex114, and others.

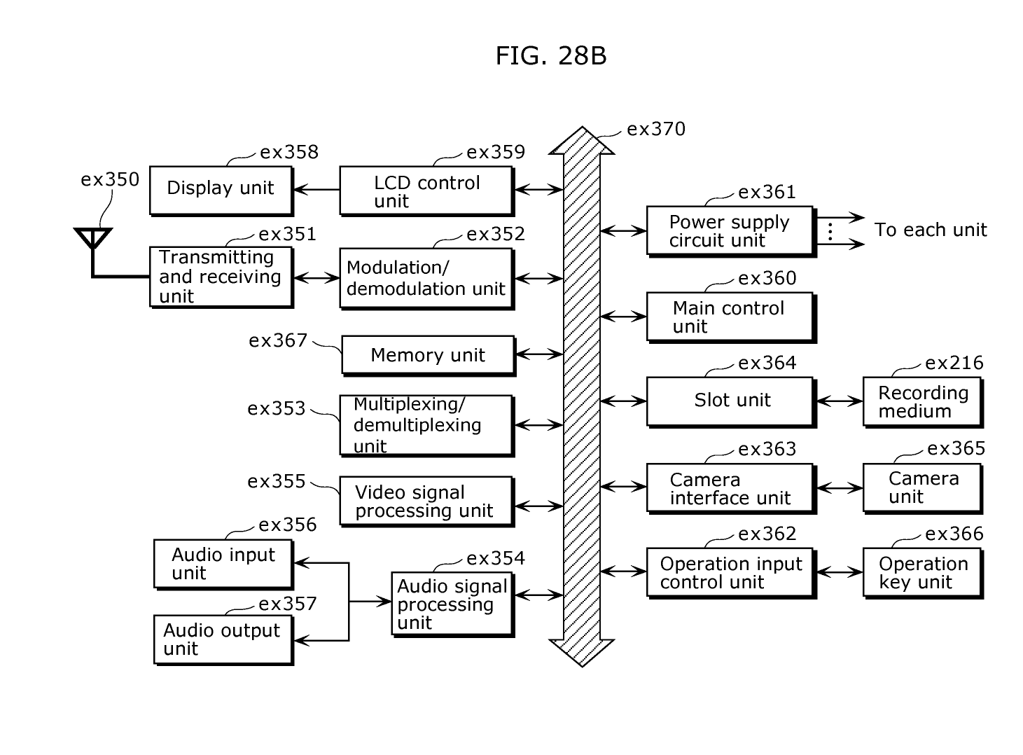

FIG. 28A illustrates the cellular phone ex114 that uses the moving picture coding method and the moving picture decoding method described in the above embodiment. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 288. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in the above embodiment (i.e., the video signal processing unit ex355 functions as the image coding apparatus according to an aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in the above embodiment (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably has 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in the above embodiment can be used in any of the devices and systems described. Thus, the advantages described in the above embodiment can be obtained.

Furthermore, various modifications and revisions can be made in the above embodiment in the present disclosure.

### Embodiment 3

Video data can be generated by switching, as necessary, between (i) the moving picture coding method or the moving picture coding apparatus shown in the above embodiment and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conforms cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in the above embodiment will be hereinafter described. The multiplexed data is a digital stream in the MPEG-2 Transport Stream format.

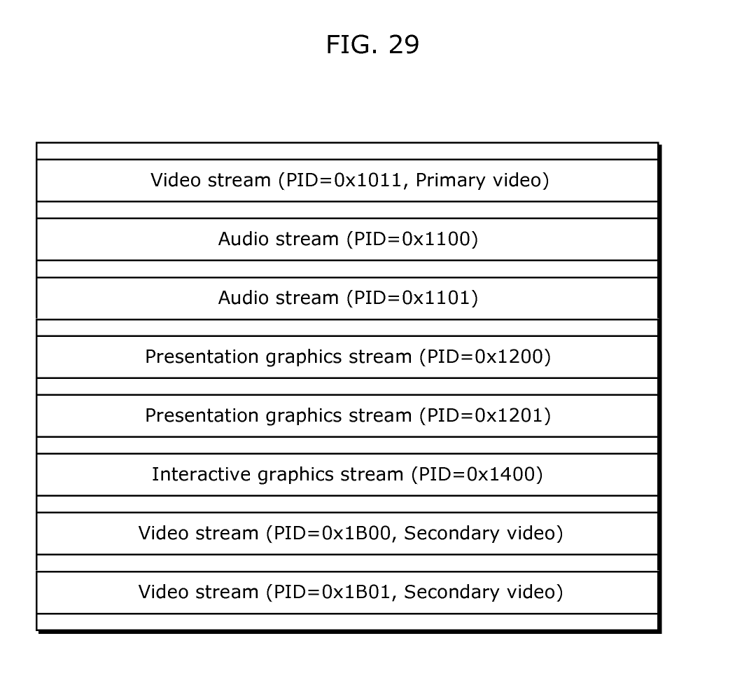

FIG. 29 illustrates a structure of the multiplexed data. As illustrated in FIG. 29, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in the above embodiment, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

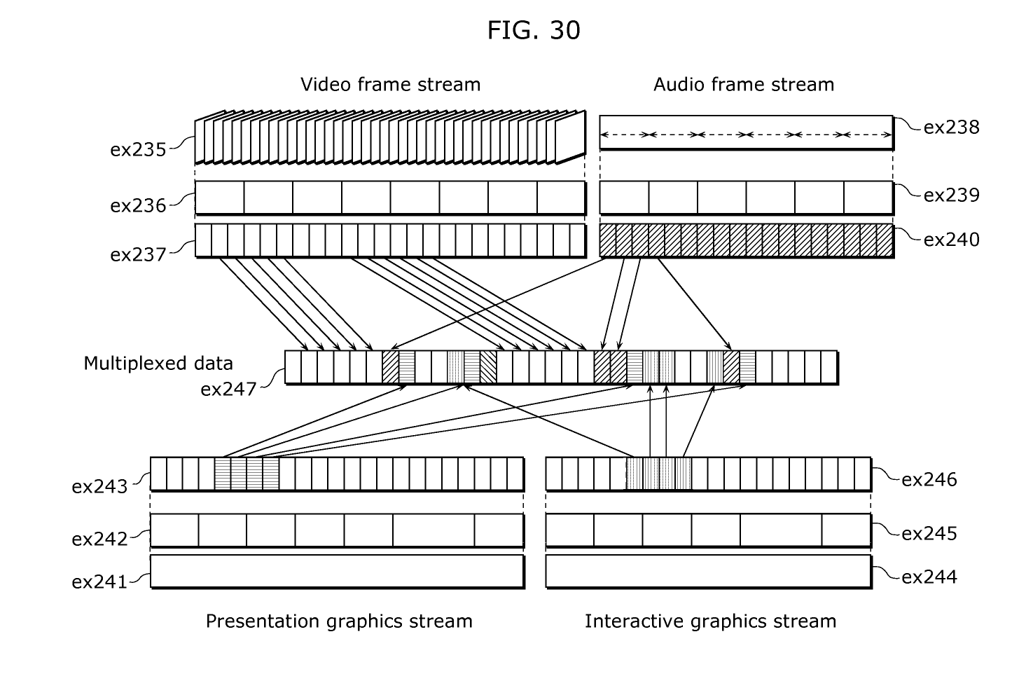

FIG. 30 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

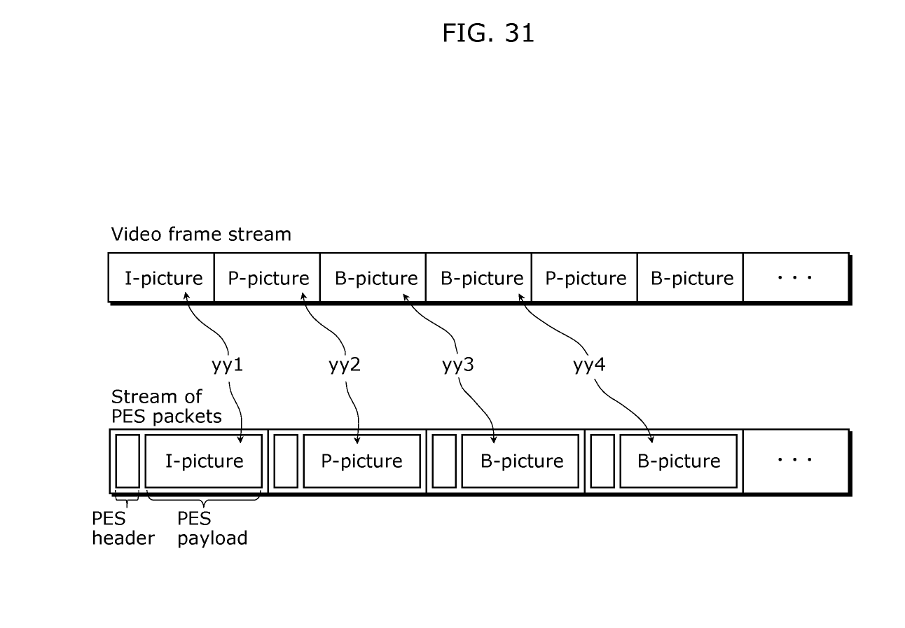

FIG. 31 illustrates how a video stream is stored in a stream of PES packets in more detail. The first bar in FIG. 31 shows a video frame stream in a video stream. The second bar shows the stream of PES packets. As indicated by arrows denoted as yy1, yy2, yy3, and yy4 in FIG. 31, the video stream is divided into pictures as I-pictures, B-pictures, and P-pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

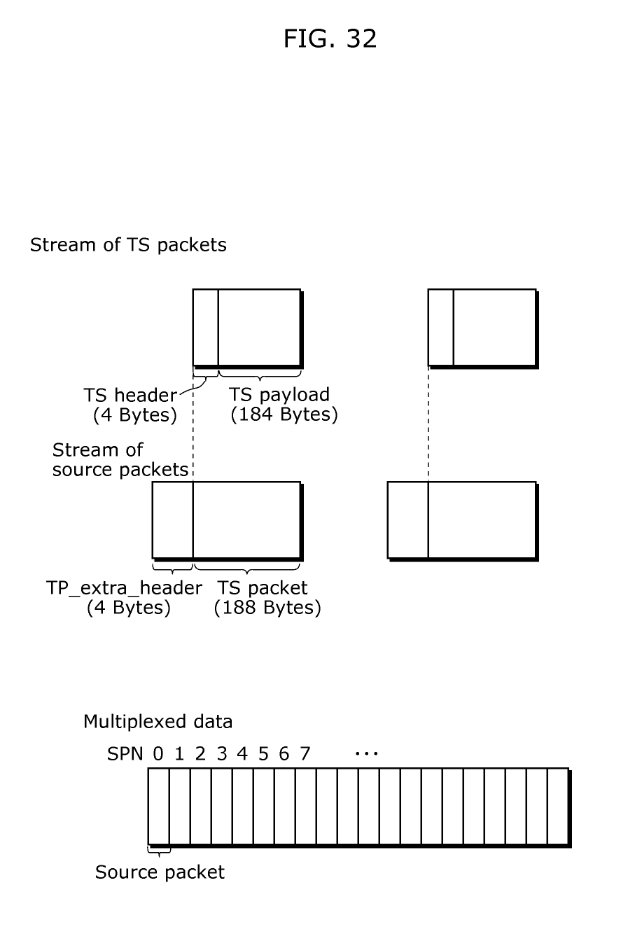

FIG. 32 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 32. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

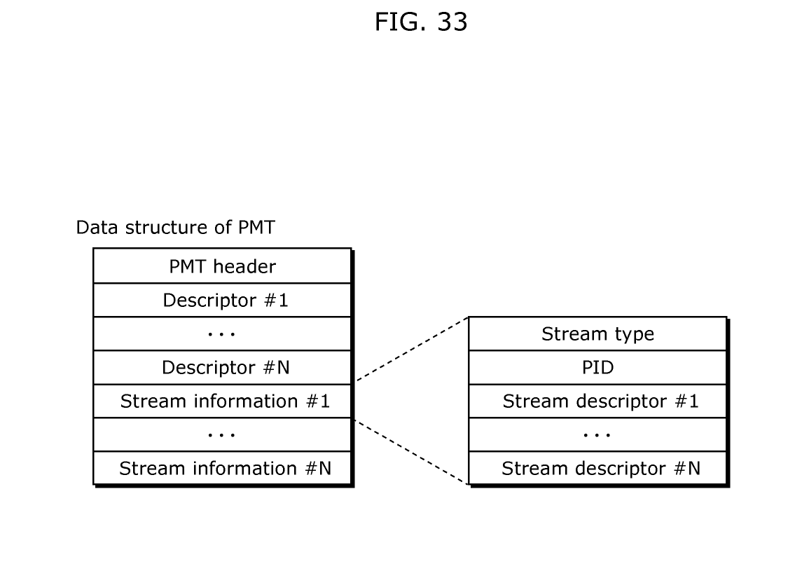

FIG. 33 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

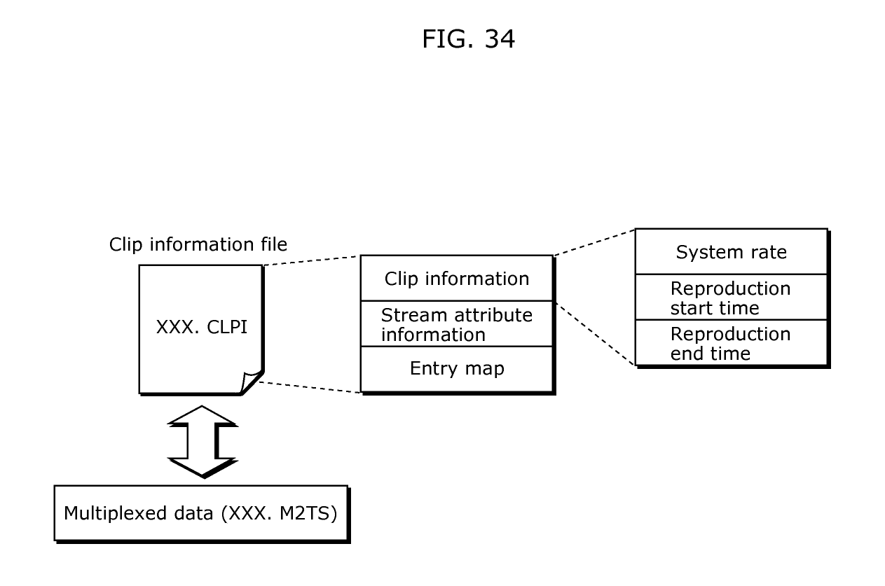

Each of the multiplexed data information files is management information of the multiplexed data as shown in FIG. 34. The multiplexed data information files are in one to one correspondence with the multiplexed data, and each of the files includes multiplexed data information, stream attribute information, and an entry map.

As illustrated in FIG. 34, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

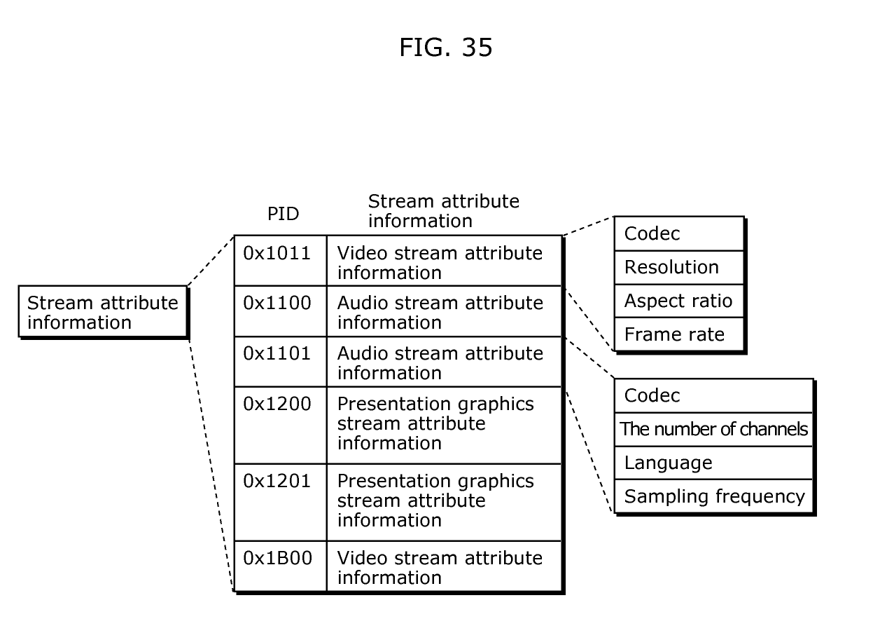

As shown in FIG. 35, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in the above embodiment includes a step or a unit for allocating unique information indicating video data generated by the moving picture coding method or the moving picture coding apparatus in the above embodiment, to the stream type included in the PMT or the video stream attribute information. With the configuration, the video data generated by the moving picture coding method or the moving picture coding apparatus described in the above embodiment can be distinguished from video data that conforms to another standard.

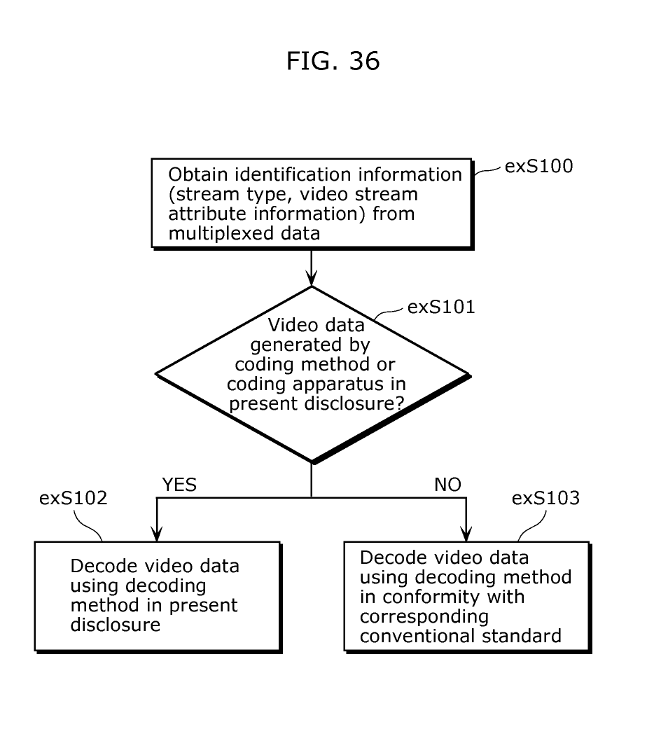

Furthermore, FIG. 36 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in the above embodiment. When it is determined that the stream type or the video stream attribute information indicates that the multiplexed data is generated by the moving picture coding method or the moving picture coding apparatus in the above embodiment, in Step exS102, decoding is performed by the moving picture decoding method in the above embodiment. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in the above embodiment can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### Embodiment 4

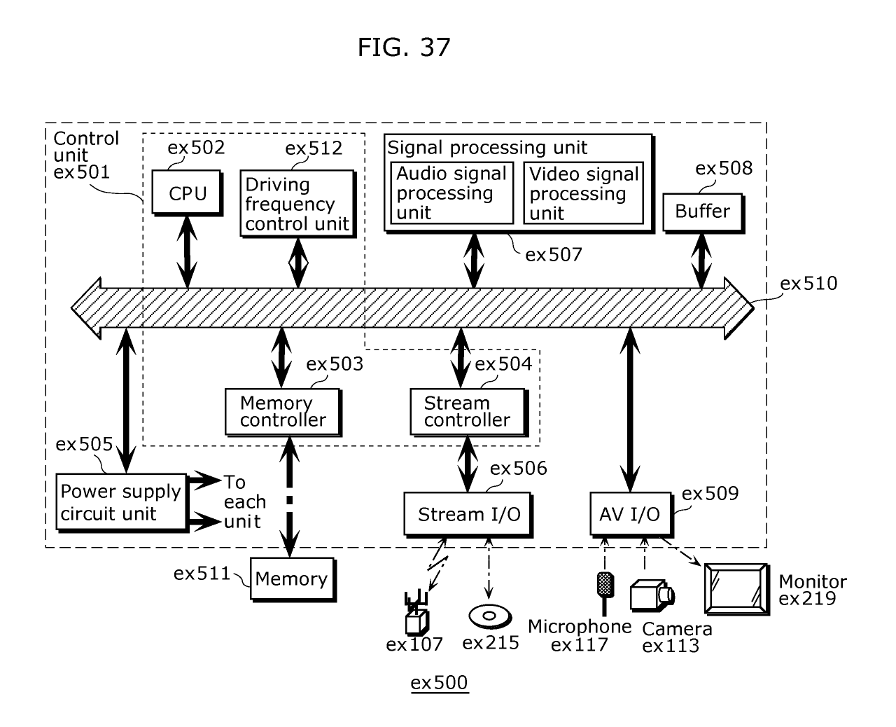

Each of the moving picture coding method, the moving picture coding apparatus, the moving picture decoding method, and the moving picture decoding apparatus in the above embodiment is typically achieved in the form of an integrated circuit or a Large Scale Integrated (LSI) circuit. As an example of the LSI, FIG. 37 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in the above embodiment. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present disclosure is applied to biotechnology.

### Embodiment 5

When video data generated in the moving picture coding method or by the moving picture coding apparatus described in the above embodiment is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

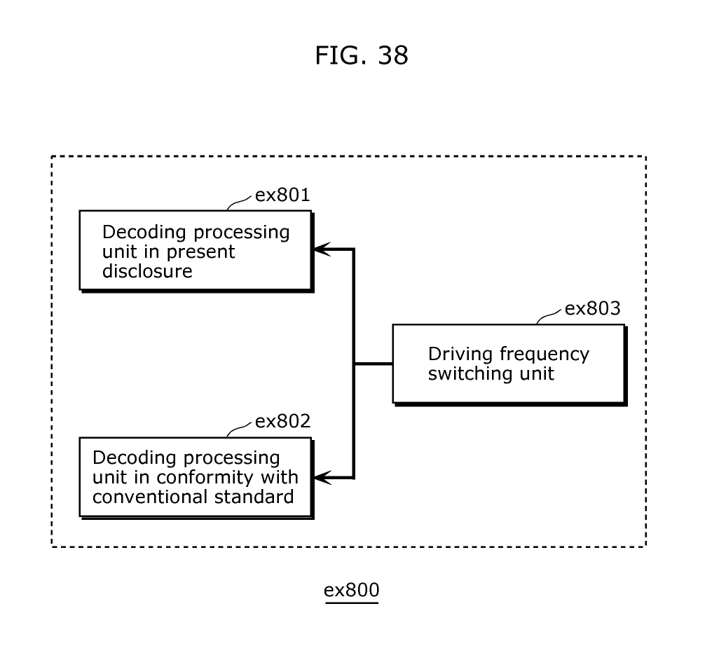

In order to solve the problem, the moving picture decoding apparatus, such as the television ex300 and the LSI ex500 is configured to determine to which standard the video data conforms, and switch between the driving frequencies according to the determined standard. FIG. 38 illustrates a configuration ex800 in the present embodiment. A driving frequency switching unit ex803 sets a driving frequency to a higher driving frequency when video data is generated by the moving picture coding method or the moving picture coding apparatus described in the above embodiment. Then, the driving frequency switching unit ex803 instructs a decoding processing unit ex801 that executes the moving picture decoding method described in the above embodiment to decode the video data. When the video data conforms to the conventional standard, the driving frequency switching unit ex803 sets a driving frequency to a lower driving frequency than that of the video data generated by the moving picture coding method or the moving picture coding apparatus described in the above embodiment. Then, the driving frequency switching unit ex803 instructs the decoding processing unit ex802 that conforms to the conventional standard to decode the video data.

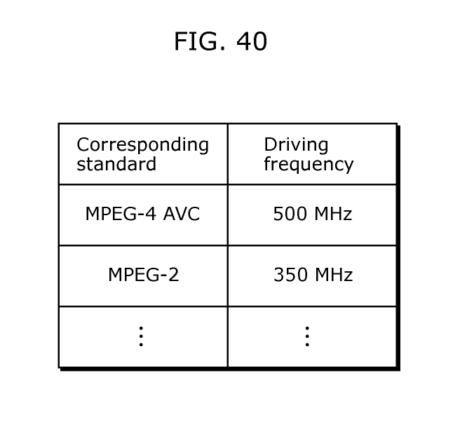

More specifically, the driving frequency switching unit ex803 includes the CPU ex502 and the driving frequency control unit ex512 in FIG. 37. Here, each of the decoding processing unit ex801 that executes the moving picture decoding method described in the above embodiment and the decoding processing unit ex802 that conforms to the conventional standard corresponds to the signal processing unit ex507 in FIG. 37. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 3 is probably used for identifying the video data. The identification information is not limited to the one described in Embodiment 3 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 40. The driving frequency can be selected by storing the look-up table in the buffer ex508 and in an internal memory of an LSI, and with reference to the look-up table by the CPU ex502.

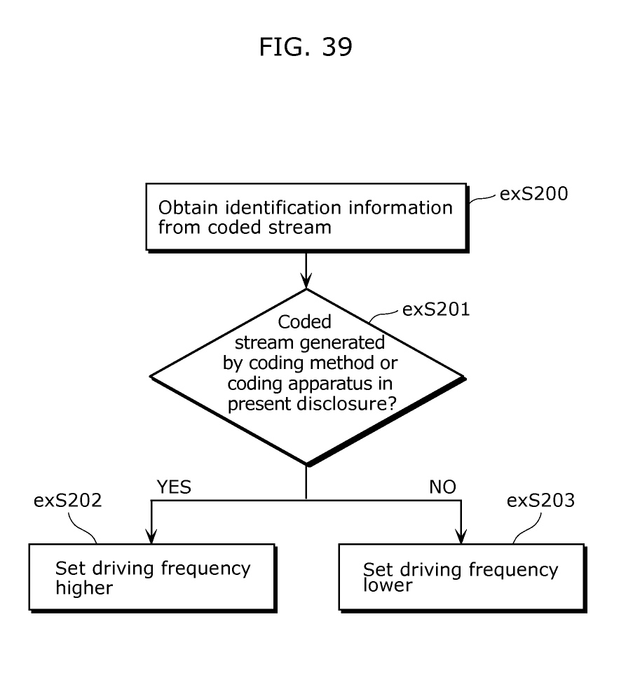

FIG. 39 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in the above embodiment, based on the identification information. When the video data is generated by the moving picture coding method and the moving picture coding apparatus described in the above embodiment, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in the above embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in the above embodiment, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in the above embodiment, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in the above embodiment, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in the above embodiment, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 6

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

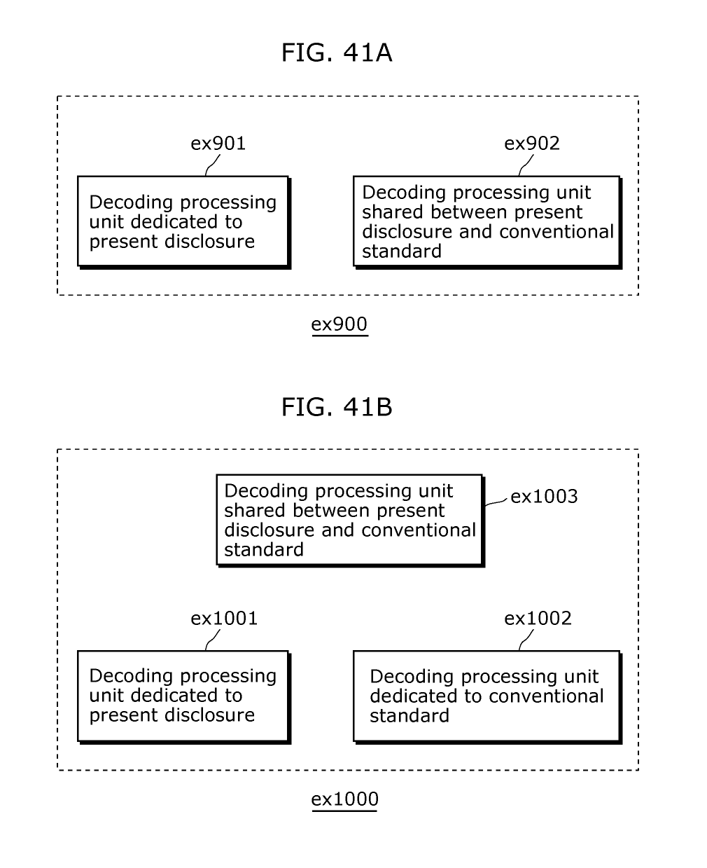

In order to solve the problem, what is conceived is a configuration in which the decoding processing unit for implementing the moving picture decoding method described in the above embodiment and the decoding processing unit that conforms to the conventional standard, such as MPEG-2, MPEG-4 AVC, and VC-1 are partly shared. Ex900 in FIG. 41A shows an example of the configuration. For example, the moving picture decoding method described in the above embodiment and the moving picture decoding method that conforms to MPEG-4 AVC have, partly in common, the details of processing, such as entropy coding, inverse quantization, deblocking filtering, and motion compensation. The details of processing to be shared probably include use of a decoding processing unit ex902 that conforms to MPEG-4 AVC. In contrast, a dedicated decoding processing unit ex901 is probably used for other processing unique to an aspect of the present disclosure. The decoding processing unit for implementing the moving picture decoding method described in the above embodiment may be shared for the processing to be shared, and a dedicated decoding processing unit may be used for processing unique to that of MPEG-4 AVC.

Furthermore, ex1000 in FIG. 41B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to an aspect of the present disclosure and the conventional moving picture decoding method. Here, the dedicated decoding processing units ex1001 and ex1002 are not necessarily specialized for the processing according to an aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to an aspect of the present disclosure and the moving picture decoding method in conformity with the conventional standard.

Although the illustrative embodiments have been described above, the scope of Claims of the present application is not limited to these embodiments. Those skilled in the art will readily appreciate that, without departing from the novel teaching and advantages of the subject matters recited in the scope of the appended Claims, it is possible to make various modifications in the above embodiments and also possible to obtain other embodiments by arbitrarily combining the structural elements in the above embodiments. Thus, such modification examples and other embodiments are included in the present disclosure.

### INDUSTRIAL APPLICABILITY

The present disclosure produces an effect of preventing image quality degradation and sufficiently improving the coding efficiency, and is available for various applications such as storage, transmission, and communication, for example. The present disclosure is of high use because it can be used, for example, for information display devices and imaging devices with high resolution which include televisions, digital video recorders, car navigation systems, cellular phones, digital cameras, and digital video cameras.

1. An image coding method for coding an input image on a per-block basis, the method comprising:
obtaining a decoded image generated by decoding a coded image resulting from coding of the input image;
setting at least one band to be variable on a per-block basis among a plurality of bands obtained by dividing possible tone levels of a pixel value of the decoded image into predetermined tone level sections, the band being subject to an offset process;
performing band offset pixel classification to classify, as one of classes, each pixel included in a current block to be processed in the decoded image, based on whether or not the pixel is included in the band which is set in the setting;
calculating a band offset value for each of the classes, the band offset value being an offset value that is an average of differences between pixel values of the input image and pixel values of the decoded image for the pixel classified as the class; and
performing a band offset process of adding the offset value to the pixel value of the decoded image for each of the classes, for the pixel classified as the class.

2. The image coding method according to claim 1, further comprising
outputting (i) an offset-processed image resulting from the offset process which involves the addition of the offset value in the performing of a band offset process and (ii) information which is used in the offset process.

3. The image coding method according to claim 1, further comprising
calculating a maximum and a minimum of the pixel values of the decoded image,
wherein in the setting, the band is set to be variable on a per-block basis, based on the maximum and the minimum calculated in the calculating of a maximum and a minimum.

4. The image coding method according to claim 3,
wherein the calculating of a maximum and a minimum includes calculating the maximum and the minimum of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction.

5. The image coding method according to claim 3,
wherein further in the setting, at least one of a total number of the bands and a width of each of the bands is set to be variable on a per-block basis, based on the maximum and the minimum calculated in the calculating of a maximum and a minimum.

6. The image coding method according to claim 1, further comprising
calculating a histogram of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction,
wherein in the setting, the band is set to be variable on a per-block basis, based on the histogram.

7. The image coding method according to claim 6,
wherein further in the setting, at least one of a total number of the bands and a width of each of the bands is set to be variable on a per-block basis, based on the histogram.

8. The image coding method according to claim 1, further comprising:
performing edge offset pixel classification to classify a pixel of the decoded image as one of classes based on an edge offset pixel classification method;
calculating an edge offset value for each of the classes, the edge offset value being an offset value that is an average of differences between pixel values of the input image and pixel values of the decoded image;
performing an edge offset process of adding the offset value to a pixel value of the decoded image for each of the classes;
calculating a cost of the edge offset pixel classification method using a difference between the input image and an offset-processed image and a code amount of information necessary for an offset process;
calculating a cost of a band offset pixel classification method using a difference between the input image and an offset-processed image and a code amount of information necessary for the offset process;
determining an optimum pixel classification method by selecting a minimum cost from among respective costs of a plurality of edge offset pixel classification methods and respective costs of a plurality of band offset pixel classification methods including the cost of the edge offset pixel classification method and the cost of the band offset pixel classification method; and
outputting (i) an offset-processed image resulting from an offset process in the optimum pixel classification method and (ii) information which is used in the offset process.

9. An image decoding method for decoding a coded stream on a per-block basis, the method comprising:
obtaining a decoded image generated by decoding the coded stream, and obtaining information which is included in the coded stream and is used in an offset process;
setting at least one band to be variable on a per-block basis among a plurality of bands obtained by dividing possible tone levels of a pixel value of the decoded image into predetermined tone level sections, the band being subject to the offset process;
performing band offset pixel classification to classify, as one of classes, each pixel included in a current block to be processed in the decoded image, based on whether or not the pixel is included in the band which is set in the setting;
performing a band offset process of adding an offset value to the pixel value of the decoded image for each of the classes, the offset value being included in the information which is obtained in the obtaining and is used in the offset process; and
outputting an offset-processed image resulting from the addition of the offset value.

10. The image decoding method according to claim 9,
wherein in the setting, the block is set to be variable on a per-block basis, based on the information which is obtained in the obtaining and is used in the offset process.

11. The image decoding method according to claim 9, further comprising
calculating a maximum and a minimum of pixel values of the decoded image,
wherein in the setting, the band is set to be variable on a per-block basis, based on the maximum and the minimum calculated in the calculating of a maximum and a minimum.

12. The image decoding method according to claim 9,
wherein the calculating of a maximum and a minimum includes calculating the maximum and the minimum of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction.

13. The image decoding method according to claim 12,
wherein further in the setting, at least one of a total number of the bands and a width of each of the bands is set to be variable on a per-block basis, based on the maximum and the minimum calculated in the calculating of a maximum and a minimum.

14. The image decoding method according to claim 9, further comprising
calculating a histogram of pixel values included in the current block, a block located above and adjacent to the current block, a block located to the left of and adjacent to the current block, the blocks located above and to the left of and adjacent to the current block, an immediately previous slice, an immediately previous frame, an immediately previous I-frame, or a reference block used in inter-frame prediction,
wherein in the setting, the band is set to be variable on a per-block basis, based on the histogram.

15. The image decoding method according to claim 14,
wherein further in the setting, at least one of a total number of the bands and a width of each of the bands is set to be variable on a per-block basis, based on the histogram.

16. An image coding apparatus which codes an input image on a per-block basis, the apparatus comprising:
an obtainment unit configured to obtain a decoded image generated by decoding a coded image resulting from coding of the input image;
a band setting unit configured to set at least one band to be variable on a per-block basis among a plurality of bands obtained by dividing possible tone levels of a pixel value of the decoded image into predetermined tone level sections, the band being subject to an offset process;
a band offset pixel classification unit configured to classify, as one of classes, each pixel included in a current block to be processed in the decoded image, based on whether or not the pixel is included in the band which is set by the band setting unit;
a band offset value calculation unit configured to calculate a band offset value for each of the classes, the band offset value being an offset value that is an average of differences between pixel values of the input image and pixel values of the decoded image for the pixel classified as the class; and
a band offset processing unit configured to add the offset value to the pixel value of the decoded image for each of the classes, for the pixel classified as the class.

17. An image decoding apparatus which decodes a coded stream on a per-block basis, the apparatus comprising:
an offset information obtainment unit configured to obtain a decoded image generated by decoding the coded stream, and obtain information which is included in the coded stream and is used in an offset process;
a band setting unit configured to set at least one band to be variable on a per-block basis among a plurality of bands obtained by dividing possible tone levels of a pixel value of the decoded image into predetermined tone level sections, the band being subject to the offset process;
a band offset pixel classification unit configured to classify, as one of classes, each pixel included in a current block to be processed in the decoded image, based on whether or not the pixel is included in the band which is set by the band setting unit;
a band offset processing unit configured to add an offset value to the pixel value of the decoded image for each of the classes, the offset value being included in the information which is obtained by the offset information obtainment unit and is used in the offset process; and
an offset image output unit configured to output an offset-processed image resulting from the addition of the offset value.

18. An image coding and decoding apparatus which codes an input image on a per-block basis and decodes, on a per-block basis, a coded stream resulting from the coding, the apparatus comprising:
the image coding apparatus according to claim 16;
an offset information obtainment unit configured to obtain a decoded image generated by decoding the coded stream, and obtain information which is included in the coded stream and is used in an offset process;
a band setting unit configured to set at least one band to be variable on a per-block basis among a plurality of bands obtained by dividing possible tone levels of a pixel value of the decoded image into predetermined tone level sections, the band being subject to the offset process;
a band offset pixel classification unit configured to classify, as one of classes, each pixel included in a current block to be processed in the decoded image, based on whether or not the pixel is included in the band which is set by the band setting unit;
a band offset processing unit configured to add an offset value to the pixel value of the decoded image for each of the classes, the offset value being included in the information which is obtained by the offset information obtainment unit and is used in the offset process; and
an offset image output unit configured to output an offset-processed image resulting from the addition of the offset value.
